(19) United States
(12) Patent Application Publication
(10) Pub. No.: US 2026/0242525 A1
(43) Pub. Date: Aug. 20, 2026

(54) RIGID GAS PERMEABLE CONTACT LENS

(71) Applicant: Bausch + Lomb Ireland Limited, Dublin (IE)

(72) Inventors: Sankarsan Biswas, Rochester, NY (US); Feng-Yang Shih, Lafayette, CO (US); James Anthony DiBella, JR., Penfield, NY (US); Bonnie J. Burris, Tewksbury, MA (US); Peter J. Tinios, Epping, NH (US); Marianne Yarmey, Rockport, MA (US); Kenneth M. Harty, Salem, NH (US); Alok Kumar Awasthi, Pittsford, NY (US)

(21) Appl. No.: 19/543,470

(22) Filed: Feb. 18, 2026

Related U.S. Application Data
(60) Provisional application No. 63/760,796, filed on Feb. 20, 2025.
(60) Provisional application No. 63/762,806, filed on Feb. 25, 2025.

(51) Int. Cl. C08F 283/12; B29D 11/00; B29K 83/00; B29K 105/00; C08F 220/28; G02B 1/04

(52) U.S. Cl. CPC C08F 283/124; C08F 220/282; G02B 1/043; B29D 11/00038; B29K 2083/00; B29K 2105/0002; C08F 2810/20

(57) ABSTRACT

A rigid gas permeable contact lens which is a polymerization product of a monomeric mixture including (a) a bulky siloxane monomer or prepolymer having an ethylenically unsaturated reactive group, (b) a non-bulky organosilicon-containing monomer having an ethylenically unsaturated reactive group, (c) a rigid gas permeable contact lens-forming comonomer, and (d) a branched cross-linking agent.

### PRIORITY CLAIM

The present application claims priority to U.S. Provisional Patent Application Ser. No. 63/762,806, entitled “Rigid Gas Permeable Contact Lens,” filed Feb. 25, 2025, and to U.S. Provisional Patent Application Ser. No. 63/760,796, entitled “Rigid Gas Permeable Contact Lens,” filed Feb. 20, 2025, the content of each of which is incorporated by reference herein in their entirety.

### BACKGROUND

Contact lenses may be classified in two general categories, soft and hard lenses. Soft contact lenses such as soft hydrogel contact lenses are made of a material with a relatively low modulus, such that the lenses are flexible and bendable. Hard contact lenses have a much higher modulus and are relatively stiff. One class of hard contact lens materials is rigid gas permeable materials. Rigid gas permeable materials can be composed of silicon-containing and non-silicone-containing material. Rigid gas permeable materials composed of silicon-containing material are able to transmit gases, particularly oxygen. Thus, oxygen can be transmitted through a rigid gas permeable contact lens and to the cornea while the lens is worn.

### SUMMARY

In accordance with an illustrative embodiment, a rigid gas permeable contact lens comprises a polymerization product of a monomeric mixture comprising:
(a) a bulky siloxane monomer or prepolymer having an ethylenically unsaturated reactive group,
(b) a non-bulky organosilicon-containing monomer having an ethylenically unsaturated reactive group,
(c) a rigid gas permeable contact lens-forming comonomer, and
(d) a branched cross-linking agent.

In accordance with another illustrative embodiment, a method for making a rigid gas permeable contact lens comprises:
(a) curing a monomeric mixture in a mold to form rigid gas permeable contact lens, the monomeric mixture comprising:
(i) a bulky siloxane monomer or prepolymer having an ethylenically unsaturated reactive group,
(ii) a non-bulky organosilicon-containing monomer having an ethylenically unsaturated reactive group,
(iii) a rigid gas permeable contact lens-forming comonomer, and
(iv) a branched cross-linking agent, and
(b) releasing the rigid gas permeable contact lens from the mold.
In accordance with yet another illustrative embodiment, a method for making a rigid gas permeable contact lens comprises:
(a) curing a monomeric mixture in a mold to form a polymerized rigid gas permeable material, the monomeric mixture comprising:
(i) a bulky siloxane monomer or prepolymer having an ethylenically unsaturated reactive group,
(ii) a non-bulky organosilicon-containing monomer having an ethylenically unsaturated reactive group,
(iii) a rigid gas permeable contact lens-forming comonomer, and
(iv) a branched cross-linking agent,
(b) releasing the polymerized rigid gas permeable material in the shape of a rod from the mold,
(c) transforming the rod into buttons, and
(d) lathing the buttons into a rigid gas permeable contact lens.

### DETAILED DESCRIPTION

Various illustrative embodiments described herein include rigid gas permeable contact lenses and methods for their fabrication.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While compositions and processes are described in terms of “comprising” various components or steps, the compositions and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, 3% of the stated value, or ±1% of the stated value.

The terms “wt. %,” “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “(meth)” as used herein denotes an optional methyl substituent. Thus, terms such as “(meth)acrylate” denotes either methacrylate or acrylate, and “(meth)acrylamide” denotes either methacrylamide or acrylamide.

As mentioned above, contact lenses may be classified in two general categories, soft and hard lenses. For hard lenses (also referred to as rigid gas permeable lenses) there are two particularly desirable properties, namely, hardness and oxygen permeability. The hardness of rigid gas permeable contact lenses is necessary so that the lens is machinable. Most rigid gas permeable contact lenses produced today are manufactured by cutting rods into buttons to machine a rigid gas permeable lens on a lathe. As an example, a rigid gas permeable prepolymer is cast in the form of a rod, the rod is cut into cylindrical disks (also referred to as buttons), and rigid gas permeable lenses are lathed from these buttons. Thus, a rigid gas permeable material must have sufficient hardness, and not be brittle, so that it is machinable.

Oxygen permeability is also a desirable property for contact lens materials since the human cornea will be damaged if it is deprived of oxygen for an extended period. Oxygen permeability is conventionally expressed in units of Barrer, and also called Dk. Oxygen transmissibility is a property of contact lens materials related to oxygen permeability where oxygen permeability is divided by lens thickness, or Dk/t.

Present formulations and manufacturing processes for making rigid gas permeable contact lenses with a high Dk of greater than 100 and hardness Shore D greater than 70 are based on per- and polyfluoroalkyl substances (PFAS) materials. Representative examples of such PFAS materials include, but are not limited to, 2,2,2-trifluoroethyl methacrylate and 1,1,1,3,3,3-hexafluoroisopropyl methacrylate. The use of fluorinated materials is undesirable because (1) PFAS materials are known as “forever” chemicals that can remain in a subject's body as well as in the environment persistently, and (2) certain PFAS materials are known for damaging organs and causing fertility issues or cancers. However, using the same manufacturing processes as associated with the PFAS materials and the use of present small chain silicone monomers where the number of —Si—O bonds in the small chain silicone monomer are limited between 1 to 6 bonds other than PFAS materials cannot achieve a comparable Dk. Thus, these rigid gas permeable contact lenses result in limiting the permeability of oxygen to the cornea, potentially causing long-term eye health issues such as hypoxia etc.

The illustrative embodiments disclosed herein overcome these and other drawbacks by providing improved rigid gas permeable contact lenses that are free of PFAS materials and have an oxygen permeability comparable, and in some cases better, than the rigid gas permeable contact lenses based on PFAS materials. In addition, the illustrative embodiments described herein further provide improved rigid gas permeable contact lenses that have a relatively high hardness thus allowing them to be machinable.

The rigid gas permeable contact lenses of the illustrative embodiments disclosed herein are based at least in part on a polymerization product of a monomeric mixture comprising (a) a bulky siloxane monomer or prepolymer having an ethylenically unsaturated reactive group, (b) a non-bulky organosilicon-containing monomer having an ethylenically unsaturated reactive group, (c) a rigid gas permeable contact lens-forming comonomer, and (d) a branched cross-linking agent.

Representative examples of the ethylenically unsaturated reactive groups for use herein include, by way of example, (meth)acrylate-containing radicals, (meth)acrylamido-containing radicals, vinylcarbonate-containing radicals, vinylcarbamate-containing radicals, styrene-containing radicals, styrene-containing radicals, itaconate-containing radicals, vinyl-containing radicals, vinyloxy-containing radicals, fumarate-containing radicals, maleimide-containing radicals, vinylsulfonyl radicals and the like.

In some embodiments, an ethylenically unsaturated reactive group is represented by the general formula:

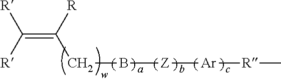

wherein R is hydrogen or a alkyl group having 1 to 6 carbon atoms such as methyl; each R′is independently hydrogen, an alkyl radical having 1 to 6 carbon atoms, or a —CO—Y—R′″ radical wherein Y is —O—, —S— or —NH— and R′″ is an alkyl radical having 1 to about 10 carbon atoms; R″ is a linking group (e.g., a divalent alkenyl radical having 1 to about 12 carbon atoms); B denotes —O—or —NH—; Z denotes —CO—, —OCO— or —COO—; Ar denotes an aromatic radical having 6 to about 30 carbon atoms; w is 0 to 6; a is 0 or 1; b is 0 or 1; and c is 0 or 1.

The monomeric mixture includes a bulky siloxane monomer or prepolymer having an ethylenically unsaturated reactive group. The term “bulky” refers to groups of a bulky siloxane monomer or prepolymer such as those represented by the structure of Formula Ia or Formula Ib that are sterically and/or electronically encumbering, i.e., sterically hindering. In a non-limiting illustrative embodiment, suitable bulky siloxane monomers include, for example, a bulky polysiloxanylalkyl (meth)acrylic monomer, a bulky polysiloxanylalkyl carbamate monomer, a bulky polysiloxanylalkyl styryl monomer and mixtures thereof. A representative example of a bulky siloxane monomer includes a bulky polysiloxanylalkyl (meth)acrylic monomer represented by a structure of Formula Ia:

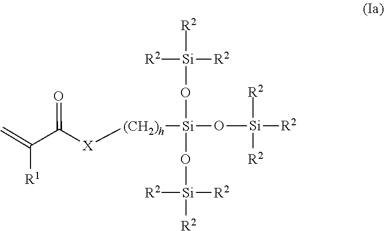

wherein X denotes —O— or —NR³—, where each R³ is hydrogen or a C₁-C₄ alkyl group; R¹ independently denotes hydrogen or methyl; each R² independently denotes an alkyl radical such as a C₁-C₆ group, a phenyl radical or a group represented by the following structure:

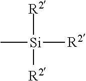

wherein each R²′ independently denotes an alkyl radical such as a C₁-C₆ group or a phenyl radical; and his 1 to 10; or a bulky siloxane monomer represented by a structure of Formula Ib:

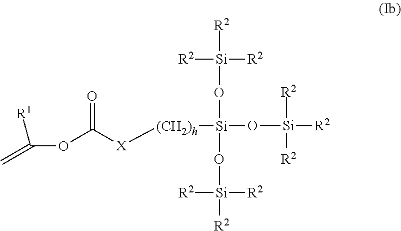

wherein X denotes —NR³— wherein R³ denotes hydrogen or a C₁-C₄ alkyl; R¹ denotes hydrogen or methyl; each R² independently denotes an alkyl radical such as a C₁-C₆ group, a phenyl radical or a group represented by the following structure:

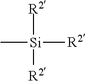

wherein each R²′ independently denotes an alkyl radical such as a C₁-C₆ group or a phenyl radical; and his 1 to 10.

A representative example of a bulky siloxane monomer includes a bulky polysiloxanylalkyl styryl monomer represented by a structure of Formula II:

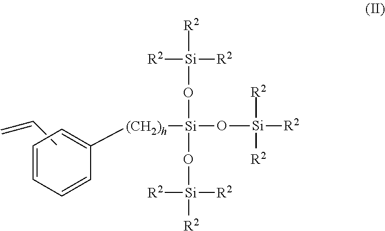

wherein each R² independently denotes an alkyl radical such as a C₁-C₆ group, a phenyl radical or a group represented by the following structure:

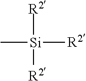

wherein each R²′ independently denotes an alkyl radical such as a C₁-C₆ group or a phenyl radical; and his 1 to 10.

Representative examples of bulky siloxane monomers include styrylethyltri (trimethylsiloxy) silane, 3-methacryloyloxypropyltris(trimethylsiloxy) silane or tris(trimethylsiloxy) silylpropyl methacrylate, sometimes referred to as TRIS, tris(trimethylsiloxy) silylpropyl vinyl carbamate, sometimes referred to as TRIS-VC, pentamethyldisiloxanyl methylmethacrylate, phenyltetramethyl-disiloxanylethyl acetate, and methyldi(trimethylsiloxy) methacryloxymethyl silane, (3-methacryloxy-2-hydroxy propoxy) propyl bis(trimethyl siloxy)methyl silane, sometimes referred to as Sigma and the like and mixtures thereof. In one embodiment, the bulky siloxane monomer is a tris(trialkylsiloxy) silylalkyl methacrylate-containing monomer such as a tris(trimethylsiloxy) silylpropyl methacrylate-containing monomer.

In a non-limiting illustrative embodiment, suitable bulky siloxane prepolymers include, for example, suitable bulky siloxane prepolymers comprising a reaction product of (a) a rigid gas permeable-forming prepolymer comprising (i) monomeric units derived from a bulky siloxane monomer having an ethylenically unsaturated reactive group; and (ii) monomeric units derived from a hydrophilic monomer having one or more reactive functionalities and an ethylenically unsaturated reactive group; and (b) a monomer having a reactive functionality complementary to one of the one or more reactive functionalities of the hydrophilic monomer and a polymerizable ethylenically unsaturated reactive group complementary to an ethylenically unsaturated reactive group of a rigid gas permeable contact lens-forming comonomer.

In an illustrative embodiment, the rigid gas permeable-forming prepolymer first includes monomeric units derived from a bulky siloxane monomer having an ethylenically unsaturated reactive group. The bulky siloxane monomer having an ethylenically unsaturated reactive group can be any of those described above.

The rigid gas permeable-forming prepolymer further includes monomeric units derived from a hydrophilic monomer having one or more reactive functionalities and an ethylenically unsaturated reactive group. In an illustrative embodiment, suitable hydrophilic monomers include, for example, those containing an active hydrogen atom such as, for example, hydrophilic monomers having hydroxyl, amino or carboxylic acid reactive functionalities and an ethylenically unsaturated reactive group as discussed above. Suitable hydroxy-substituted hydrophilic monomers include, for example, hydroxy (meth)acrylates and (meth)acrylamides, such as 2-hydroxyethyl methacrylate (HEMA), 2-hydroxyethyl acrylate (HEA), 4-hydroxybutyl acrylate, 4-hydroxybutyl methacrylate, glycerol methacrylate, glycerol acrylate, polyethylene glycol methacrylate, polyethylene glycol acrylate, N-2-hydroxyethyl methacrylamide and the like and mixtures thereof. Amino-substituted monomers include allyl amine.

In an illustrative embodiment, the rigid gas permeable-forming prepolymers disclosed herein can be prepared using techniques of controlled radical polymerization, e.g., by reversible addition-fragmentation chain transfer (RAFT) polymerization or atom-transfer radical polymerization (ATRP) employing a chain transfer agent that allows construction of the rigid gas permeable-forming prepolymers with a well-defined molecular weight distribution and narrow polydispersity. RAFT polymerization is particularly preferred because it is compatible with a wide variety of vinyl monomers.

In one illustrative embodiment, the rigid gas permeable-forming prepolymers can be obtained by first (1) mixing the bulky siloxane monomer having an ethylenically unsaturated reactive group and the hydrophilic monomer having one or more reactive functionalities and an ethylenically unsaturated reactive group with a suitable chain transfer agent; (2) adding a polymerization initiator; and (3) subjecting the monomer/initiator mixture to a source of heat. The chain transfer agent serves to control the molecular weight of the resultant copolymer and provides hydroxy- or amino-functionality to the resultant polymer. Suitable chain transfer agents include mercapto alcohols (also referred to as hydroxymercaptans) and aminomercaptans such as, for example, hydroxyethylmercaptan, mercaptoethanol, and the like. Typical initiators include free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobis-isobutyronitrile (AIBN).

The reaction can be carried out at a temperature of between about 15° C. to about 120° C. for a time period of about 30 minutes to about 72 hours. The reaction can be carried out in the presence of a suitable solvent. Suitable solvents are in principle all solvents which dissolve the monomer used, for example, carboxamides such as dimethylformamide; dipolar aprotic solvents such as dimethyl sulfoxide; ketones such as acetone or cyclohexanone; hydrocarbons such as toluene, acetates such as anhydrous ethyl acetate and the like.

In an illustrative embodiment, the bulky siloxane monomer having an ethylenically unsaturated reactive group is employed in an amount ranging from about 20 wt. % to about 95 wt. %, based on the total weight of the mixture. In an illustrative embodiment, the hydrophilic monomer having one or more reactive functionalities and an ethylenically unsaturated reactive group is employed in an amount ranging from about 3 wt. % to about 20 wt. %, based on the total weight of the mixture. In an illustrative embodiment, the chain transfer agent is employed in an amount ranging from about 0.1 wt. % to about 5 wt. %, based on the total weight of the mixture. The level of initiator employed will vary within the range of about 0.01 wt. % to about 2 wt. % of the mixture of monomers. If desired, the mixture of the above-mentioned monomers is warmed with addition of a free-radical former such as, for example, Luperox 26, Luperox 265, AIBN, Irgacure 819, and PTO.

A non-limiting schematic representation of a synthetic method for making the rigid gas permeable-forming prepolymer with a RAFT agent is set forth below in Scheme I.

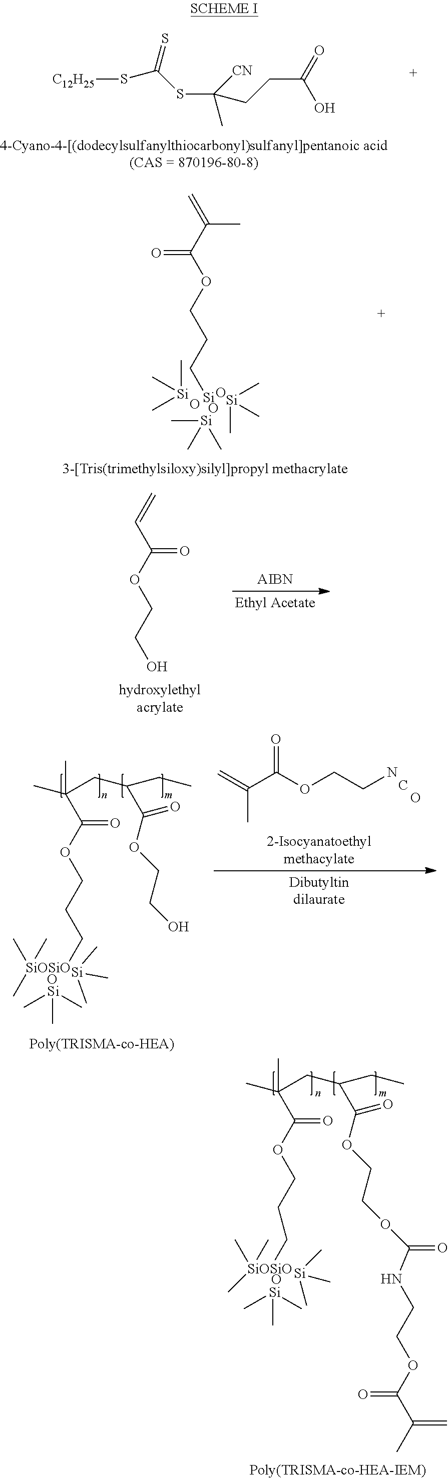

In the case where the rigid gas permeable-forming prepolymer disclosed herein is obtained from ATRP polymerization, the ethylenically unsaturated groups may be introduced by appropriate selection of a suitable ATRP initiator or by displacement reactions of the terminal halogen atom. Suitable ATRP groups for use herein include any standard monofunctional or difunctional ATRP group as is well known to those of ordinary skill in the art. A comprehensive review on the use of ATRP initiators or displacement of the terminal halogen using electrophilic, nucleophilic, and radical reactions to produce telechelic polymers is disclosed in, for example, Matyjaszewski, K.; Xia, J. Chem. Rev., 101, 2921-2990 (2001).

In one embodiment, a useful ATRP group includes an ethylenically unsaturated ATRP initiator such as, for example, vinyl functionalized ATRP initiators, e.g., prop-2-enyl-2′-bromoisobutyrate, vinyl chloroacetate, allyl chloroacetate, allyl bromide and the like. These initiators are used to polymerize either hydrophilic monomers or hydrophobic monomers.

In another embodiment, a useful ATRP group includes a non-ethylenically unsaturated ATRP initiator that can be converted to an ethylenically unsaturated initiator by a subsequent step. Examples of such initiators include a -bromo-isobutyric acid, hydroxyethyl 2-bromopropionate, glycidol 2-bromopropionate, tert-butyl 2-bromopropionate, and 4-bromobenzyl bromide, and the like.

In an illustrative embodiment, the rigid gas permeable-forming prepolymer is obtained from ATRP polymerization in a first step (a) by mixing either the bulky siloxane monomer having an ethylenically unsaturated reactive group or the hydrophilic monomer having one or more reactive functionalities and an ethylenically unsaturated reactive group with, for example, an ATRP initiator and suitable ATRP catalyst such as a copper (I) bromide and subjecting the monomer/ATRP agent/initiator mixture to a source of heat. The reaction can be carried out at a temperature of between about 15° C. to about 120° C. for a time period of about 30 minutes to about 48 hours. If desired, the reaction can be carried out in the presence of a suitable solvent. Suitable solvents are in principle all solvents which dissolve the monomers used, for example, 1,4-dioxane, hexanol, dimethylformamide; acetone, cyclohexanone, toluene, and the like and mixtures thereof.

In an illustrative embodiment, the bulky siloxane monomer having an ethylenically unsaturated reactive group or the hydrophilic monomer having one or more reactive functionalities and an ethylenically unsaturated reactive group is employed in an amount ranging from about 20 wt. % to about 95 wt. %, based on the total weight of the mixture. In an illustrative embodiment, the ATRP initiator is employed in an amount ranging from about 0.1 wt. % to about 5 wt. %, based on the total weight of the mixture. The level of catalyst employed will vary within the range of about 0.1 wt. % to about 5 wt. % of the mixture of monomers.

Next, in step (b) the resulting product of step (a) is then mixed with the other one of the bulky siloxane monomer having an ethylenically unsaturated reactive group or the hydrophilic monomer having one or more reactive functionalities and an ethylenically unsaturated reactive group and an initiator and subjected to a source of heat as described above until the desired rigid gas permeable-forming prepolymer is formed. In an illustrative embodiment, the other one of the bulky siloxane monomer having an ethylenically unsaturated reactive group or the hydrophilic monomer having one or more reactive functionalities and an ethylenically unsaturated reactive group is employed in an amount ranging from about 5 wt. % to about 30 wt. %, based on the total weight of the mixture. In an illustrative embodiment, the resulting product of step (a) is employed in an amount ranging from about 5 wt. % to about 20 wt. %, based on the total weight of the mixture.

The reaction can be carried out at a temperature of between about 30° C. to about 60° C. for about 30 minutes to about 24 hours. The reaction can be carried out in the presence of a suitable solvent as discussed above.

A non-limiting schematic representation of a synthetic method for making the rigid gas permeable-forming prepolymer with an ATRP agent is set forth below in Scheme II.

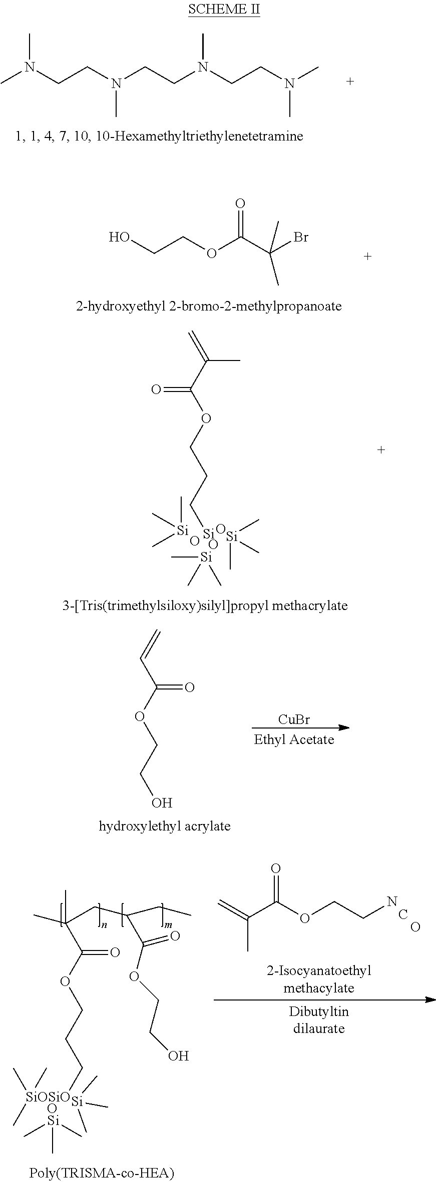

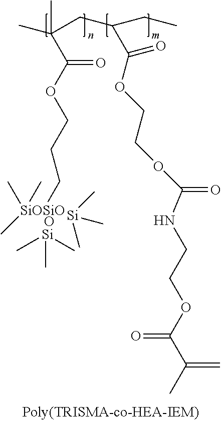

In one or more additional non-limiting illustrative embodiments, as may be combined with one or more of the preceding paragraphs, the rigid gas permeable-forming prepolymer is thereafter reacted with a monomer having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer. As one skilled in the art will readily understand, the foregoing reaction will functionalize at least one of the one or more reactive functionalities present in the monomeric units derived from the hydrophilic monomer so that the monomeric units derived from the hydrophilic monomer will have an end functionalized group, i.e., a polymerizable ethylenically unsaturated reactive end group complementary to an ethylenically unsaturated reactive group of a rigid gas permeable contact lens-forming comonomer as discussed below. Suitable polymerizable ethylenically unsaturated reactive end groups can be any of those discussed above.

In an illustrative embodiment, a polymerizable ethylenically unsaturated reactive end group can be one or more of an acrylate and a methacrylate end group.

Suitable monomers having a reactive functionality complementary to one of the one or more reactive functionalities of the hydrophilic monomer and a polymerizable ethylenically unsaturated reactive end group complementary to an ethylenically unsaturated reactive group of a rigid gas permeable contact lens-forming comonomer include, for example, 2-isocyanatoethyl acrylate, 3-isocyanatopropyl acrylate, 2-isocyanatoethyl methacrylate, 1-methyl-2-isocyanatoethyl methacrylate, 1,1-dimethyl-2-isocyanatoethyl acrylate, (meth)acryloyl chloride and the like.

In an illustrative embodiment, the rigid gas permeable-forming prepolymer is present in the reaction mixture in an amount ranging from about 5 wt. % to about 80 wt. %, based on the total weight of the reaction mixture. In an illustrative embodiment, the rigid gas permeable-forming prepolymer is present in the reaction mixture in an amount ranging from about 5 wt. % to about 65 wt. %, based on the total weight of the reaction mixture. In an illustrative embodiment, the monomer has a reactive functionality complementary to one of the one or more reactive functionalities of the hydrophilic monomer and a polymerizable ethylenically unsaturated reactive end group present in the reaction mixture in an amount ranging from about 1 wt. % to about 10 wt. %, based on the total weight of the mixture. In an illustrative embodiment, the monomer having a reactive functionality complementary to one of the one or more reactive functionalities of the hydrophilic monomer and a polymerizable ethylenically unsaturated reactive end group present in the reaction mixture in an amount ranging from about 1 wt. % to about 7 wt. %, based on the total weight of the mixture.

The reaction of the rigid gas permeable-forming prepolymer and the monomer having a reactive functionality complementary to one of the one or more reactive functionalities of the hydrophilic monomer and a polymerizable ethylenically unsaturated reactive end group can be carried out in the presence of a catalyst. Suitable catalysts include, for example, the stannous salts of carboxylic acids, such as stannous octoate, stannous oleate, stannous acetate, and stannous laurate, dialkyltin dicarboxylates, such as dibutyltin dilaurate and dibutyltin diacetate which are known in the art as urethane catalysts, as are tertiary amines and tin mercaptides. The amount of catalyst employed is generally between about 0.01 wt. % to about 5 wt. % of the mixture catalyzed.

The reaction can be carried out at a temperature of between about 0° C. to about 45° C. for about 1 to about 24 hours. The reaction can be carried out in the presence of a suitable solvent as discussed above.

As one skilled in the art will readily appreciate, the rigid gas permeable prepolymer of the reaction product will contain a balance of monomeric units derived from a bulky siloxane monomer containing an ethylenically unsaturated reactive end group, and monomeric units derived from a hydrophilic monomer having one or more reactive functionalities and an ethylenically unsaturated reactive end group. In non-limiting illustrative embodiments, the number of monomeric units derived from a bulky siloxane monomer containing an ethylenically unsaturated reactive end group can be from about 30 units to about 500 units. In another non-limiting illustrative embodiment, the number of monomeric units derived from a bulky siloxane monomer containing an ethylenically unsaturated reactive end group can be from about 40 to about 300 units. In another non-limiting illustrative embodiment, the number of monomeric units derived from a bulky siloxane monomer containing an ethylenically unsaturated reactive end group can be from about 50 units to about 100 units.

In non-limiting illustrative embodiments, the number of monomeric units derived from a hydrophilic monomer having one or more reactive functionalities and an ethylenically unsaturated reactive end group can be from about 10 units to about 100 units. In another non-limiting illustrative embodiment, the number of monomeric units derived from a hydrophilic monomer having one or more reactive functionalities and an ethylenically unsaturated reactive end group can be from about 10 units to about 50 units. In another non-limiting illustrative embodiment, the number of monomeric units derived from a hydrophilic monomer having one or more reactive functionalities and an ethylenically unsaturated reactive end group can be from about 10 units to about 30 units.

In non-limiting illustrative embodiments, the number of one or more additional monomeric units such as those derived from one or more monofunctional silicone comonomers having an ethylenically unsaturated polymerizable group can be from about 20 units to about 100 units. In another non-limiting illustrative embodiment, the number of one or more additional monomeric units such as those derived from one or more monofunctional silicone comonomers having an ethylenically unsaturated polymerizable group can be from about 5 to about 20 units.

Any combination of the forgoing ranges of numbers of monomeric units derived from a bulky siloxane monomer containing an ethylenically unsaturated reactive end group, the number of monomeric units derived from a hydrophilic monomer having one or more reactive functionalities and an ethylenically unsaturated reactive end group and the number of the one or more additional monomeric units are contemplated herein.

In an illustrative embodiment, the bulky siloxane monomer or prepolymer can be present in the monomeric mixture in an amount ranging from about 30 wt. % to about 75 wt. %, based on the total weight of the monomeric mixture. In some embodiments, the bulky siloxane monomer or prepolymer can be present in the monomeric mixture in an amount ranging from about 45 wt. % to about 70 wt. %, based on the total weight of the monomeric mixture. In an illustrative embodiment, the bulky siloxane monomer or prepolymer can be present in the monomeric mixture in a major amount, e.g., an amount of greater than or equal to 50 wt. %, based on the total weight of the monomeric mixture. In an illustrative embodiment, the bulky siloxane monomer or prepolymer can be present in the monomeric mixture in an amount of from about 50 wt. % to about 75 wt. %, based on the total weight of the monomeric mixture.

In one or more additional non-limiting illustrative embodiments, as may be combined with one or more of the preceding paragraphs, the monomeric mixture will further include one or more non-bulky organosilicon-containing monomers having an ethylenically unsaturated reactive group. An “organosilicon-containing monomer” as used herein contains at least one [siloxanyl] or at least one [silyl-alkyl-siloxanyl] repeating unit, in a monomer, macromer or prepolymer. In an illustrative embodiment, an example of a non-bulky organosilicon-containing monomers is represented by a structure of Formula III:

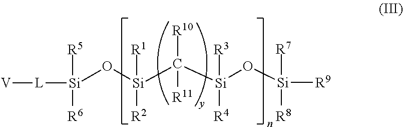

wherein V is an ethylenically unsaturated reactive group, L is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R 10 and R¹¹ is hydrogen; y is 2 to 7 and n is 1 to 100 or from 1 to 20.

Representative examples of alkyl groups for use herein include, by way of example, a linear or branched hydrocarbon chain radical containing carbon and hydrogen atoms of from 1 to about 30 carbon atoms or from 1 to 12 carbon atoms or from 1 to 6 carbon atoms with or without unsaturation, to the rest of the molecule, e.g., methyl, ethyl, n-propyl, 1-methylethyl(isopropyl), n-butyl, n-pentyl, etc., and the like.

Representative examples of alkenyl groups for use herein include, by way of example, a straight or branched hydrocarbon chain radical containing from about 3 to about 30 carbon atoms with at least one carbon-carbon double bond such as, for example, propenyl, butenyl, pentenyl and the like.

Representative examples of cycloalkyl groups for use herein include, by way of example, a substituted or unsubstituted non-aromatic mono or multicyclic ring system of about 3 to about 30 carbon atoms or from 3 to 12 carbon atoms or from 3 to 6 carbon atoms such as, for example, cyclopropyl, cyclobutyl, cyclopentyl, cyclohexyl, perhydronapththyl, adamantyl and norbornyl groups bridged cyclic group or sprirobicyclic groups, e.g., sprio-(4, 4)-non-2-yl and the like, optionally containing one or more heteroatoms, e.g., O and N, and the like.

Representative examples of heterocycloalkyl groups for use herein include, by way of example, a substituted or unsubstituted stable 3 to about 15 membered ring radical, containing carbon atoms and from one to five heteroatoms, e.g., nitrogen, phosphorus, oxygen, sulfur and mixtures thereof that is attached to the molecule by way of an alkyl group. Suitable heterocyclic ring radicals for use herein may be a monocyclic, bicyclic or tricyclic ring system, which may include fused, bridged or spiro ring systems, and the nitrogen, phosphorus, carbon, oxygen or sulfur atoms in the heterocyclic ring radical may be optionally oxidized to various oxidation states. Examples of such heterocyclic groups include, but are not limited to, azetidinyl, acridinyl, benzodioxolyl, benzodioxanyl, benzofurnyl, carbazolyl, cinnolinyl, dioxolanyl, indolizinyl, naphthyridinyl, perhydroazepinyl, phenazinyl, phenothiazinyl, phenoxazinyl, phthalazinyl, pyridyl, pteridinyl, purinyl, quinazolinyl, quinoxalinyl, quinolinyl, isoquinolinyl, tetrazoyl, imidazolyl, tetrahydroisouinolyl, piperidinyl, piperazinyl, 2-oxopiperazinyl, 2-oxopiperidinyl, 2-oxopyrrolidinyl, 2-oxoazepinyl, azepinyl, pyrrolyl, 4-piperidonyl, pyrrolidinyl, pyrazinyl, pyrimidinyl, pyridazinyl, oxazolyl, oxazolinyl, oxasolidinyl, triazolyl, indanyl, isoxazolyl, isoxasolidinyl, morpholinyl, thiazolyl, thiazolinyl, thiazolidinyl, isothiazolyl, quinuclidinyl, isothiazolidinyl, indolyl, isoindolyl, indolinyl, isoindolinyl, octahydroindolyl, octahydroisoindolyl, quinolyl, isoquinolyl, decahydroisoquinolyl, benzimidazolyl, thiadiazolyl, benzopyranyl, benzothiazolyl, benzooxazolyl, furyl, tetrahydrofurtyl, tetrahydropyranyl, thienyl, benzothienyl, thiamorpholinyl, thiamorpholinyl sulfoxide, thiamorpholinyl sulfone, dioxaphospholanyl, oxadiazolyl, chromanyl, isochromanyl and the like and mixtures thereof.

Representative examples of aryl groups for use herein include, by way of example, a substituted or unsubstituted monoaromatic or polyaromatic radical containing from about 5 to about 30 carbon atoms or from 5 to 12 carbon atoms or from 5 to 8 carbon atoms such as, for example, phenyl, naphthyl, tetrahydronapthyl, indenyl, biphenyl and the like, optionally containing one or more heteroatoms, e.g., O and N, and the like.

Ethylenically unsaturated reactive groups include those discussed above including, for example, (meth)acrylates, vinyl carbonates, O-vinyl carbamates, N-vinyl carbamates, and (meth)acrylamides.

Linking groups can be any divalent radical or moiety and include, for example, substituted or unsubstituted C₁ to C₁₂ alkyl group, an alkyl ether group, an alkenyl group, an alkenyl ether group, a halo alkyl group, a substituted or unsubstituted siloxane group, and monomers capable of propagating ring opening.

In one embodiment, V is a (meth)acrylate, L is a C₁ to C₁₂ alkylene group, R¹, R², R³, R⁴, R⁵, R⁶, R⁷, R⁸, and R° are independently a C₁ to C₁₂ alkyl group, R¹⁰ and R¹¹ are independently H or a C₁ to C₁₂ alkyl group, y is 2 to 7 and n is 3 to 8.

In one embodiment, V is a (meth)acrylate, L is a C₁ to C₆ alkyl group, R¹, R², R³, R⁴, R⁵, R⁶, R⁷, R⁸, and R⁹ are independently a C₁ to C₆ alkyl group, R¹⁰ and R¹¹ are independently H or a C₁ to C₆ alkyl group, y is 2 to 7 and n is 1 to 20.

In an illustrative embodiment, as may be combined with one or more of the preceding paragraphs, the one or more non-bulky organosilicon-containing monomers can also comprise a compound represented by a structure of Formula IV:

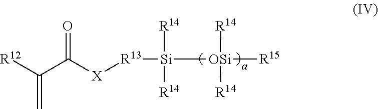

wherein R¹² is H or methyl; X is O or NR¹⁶, wherein R¹⁶ is selected from H, or C₁ to C₄ alkyl, which may be further substituted with one or more hydroxyl groups, and in some embodiments is H or methyl; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof, and in yet another embodiment a C₁ or C₃ to C₄ alkylene group which may be substituted with ether, hydroxyl and combinations thereof; each R¹⁴ is independently a phenyl or a C to C₄ alkyl group which may be substituted with fluorine, hydroxyl or ether, and in another embodiment each R¹⁴ is independently selected from ethyl and methyl groups, and in yet another embodiment, each R¹⁴ is methyl; R¹⁵ is a C₁ to C₄ alkyl group; a is 2 to 50, and in some embodiments 5 to 15.

Non-bulky organosilicon-containing monomers represented by a structure of Formula IV are known in the art, see, e.g., U.S. Pat. Nos. 8,703,891, 8,937,110, 8,937,111, 9,156,934 and 9,244,197, the contents of which are incorporated by reference herein.

Representative examples of the non-bulky organosilicon-containing monomers include:

M1EDS6: a compound having the structure and available from Gelest:

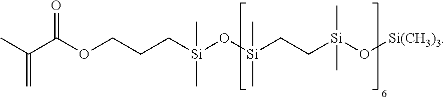

MCR-M11: a compound having the structure:

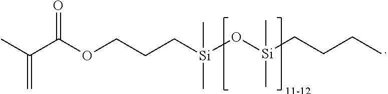

M1-MCR-C₁₂: a compound having the structure:

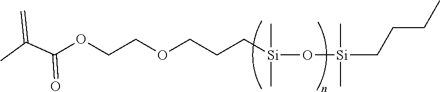

wherein n is an average of 12.

In an illustrative embodiment, as may be combined with one or more of the preceding paragraphs, a class of representative non-bulky organosilicon-containing monomers includes one or more polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacrylates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae V and VI:

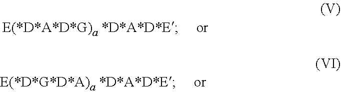

wherein:
D independently denotes an alkyl diradical, an alkyl cycloalkyl diradical, a cycloalkyl diradical, an aryl diradical or an alkylaryl diradical having 6 to about 30 carbon atoms;
G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
* denotes a urethane or ureido linkage;
a is at least 1;
A independently denotes a divalent polymeric radical of Formula VII:

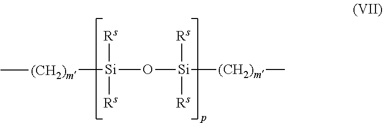

wherein each R⁸ independently denotes an alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula VIII:

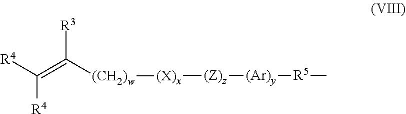

wherein: R³ is hydrogen or methyl;
R⁴ is hydrogen, an alkyl radical having 1 to 6 carbon atoms, or a —CO—Y—R⁶ radical wherein Y is —O—, —S— or —NH—;
R⁵ is a divalent alkylene radical having 1 to about 10 carbon atoms;
R⁶ is an alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

In an illustrative embodiment, as may be combined with one or more of the preceding paragraphs, a class of representative non-bulky organosilicon-containing monomers includes one or more silicone-containing urethane monomers represented by Formula IX:

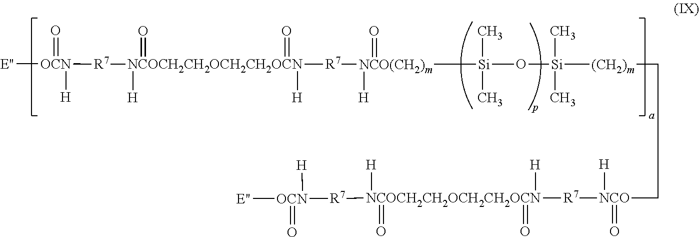

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

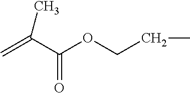

In an illustrative embodiment, as may be combined with one or more of the preceding paragraphs, a class of representative non-bulky organosilicon-containing monomers includes one or more monomers of Formula X:

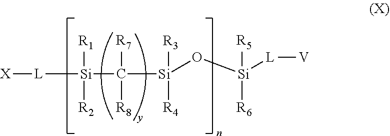

wherein X is the residue of a ring opening agent; L is the same or different and is a linking group or a bond; V is an ethylenically unsaturated reactive group; R₁, R₂, R₃, R₄, R₅, R₆ are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and nis 1-100.

Ring opening agents are well known in the literature. Non-limiting examples of anionic ring opening agents include alkyl lithium, an alkoxide, trialkylsiloxylithium wherein the alkyl group may or may not contain halo atoms.

Linking groups can be any divalent radical or moiety and include substituted or unsubstituted alkyl, alkyl ether, alkenyls, alkenyl ethers, halo alkyls, substituted or unsubstituted siloxanes, and monomers capable of propagating ring opening.

Ethylenically unsaturated reactive groups are well known to those skilled in the art. Non-limiting examples of ethylenically unsaturated reactive groups would include acrylates, methacrylates, vinyl carbonates, O-vinyl carbamates, N-vinyl carbamates, acrylamides and methacrylamides.

In an illustrative embodiment, as may be combined with one or more of the preceding paragraphs, a class of representative non-bulky organosilicon-containing monomers includes one or more monomers of Formula XI:

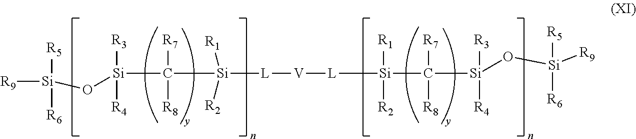

wherein L is the same or different and is a linking group or a bond; V is the same or different and is an ethylenically unsaturated reactive group; R₁, R₂, R₃, R₄, R₅, R₆ and R₉ are independently hydrogen, an alkyl group, a haloalkyl group, a cycloalkyl group, a heterocycloalkyl group, an alkenyl group, a halo alkenyl group, or an aromatic group; R⁷ and R₅ are independently hydrogen or an alkyl group wherein at least one of R₇ or R₈ is hydrogen; y is 2-7 and n is 1-100.

In an illustrative embodiment, as may be combined with one or more of the preceding paragraphs, a class of representative non-bulky organosilicon-containing monomers includes one or more monomers of Formulae XII and XIII:

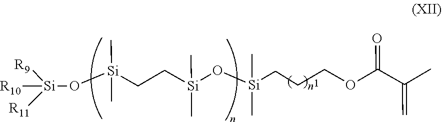

wherein R₉, R₁₀ and R₁₁ are independently hydrogen, an alkyl group, a haloalkyl group or other substituted alkyl groups; n is as defined above and n¹ is 0-10; and,

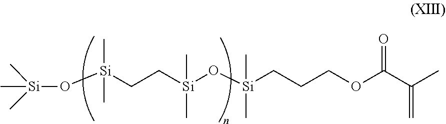

wherein n is 1 to 100, or nis 2 to 80, or n is 3 to 20, or n is 5 to 15.

In an illustrative embodiment, as may be combined with one or more of the preceding paragraphs, a class of representative non-bulky organosilicon-containing monomers includes one or more monomers of Formulas XIV-XVIII:

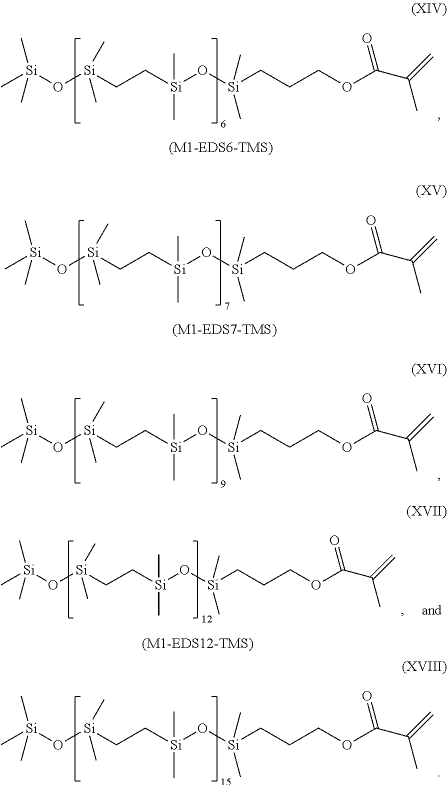

In an illustrative embodiment, as may be combined with one or more of the preceding paragraphs, a class of representative non-bulky organosilicon-containing monomers includes one or more monomers of Formulas XIX-XXI:

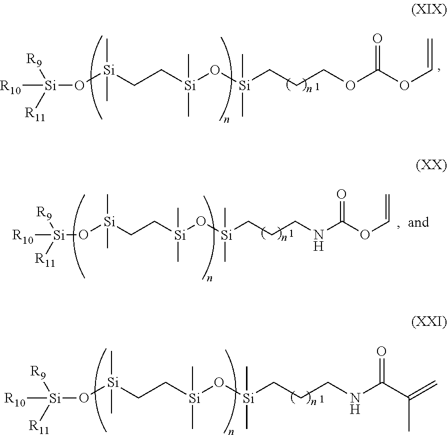

wherein R₉, R₁₀ and R₁₁ are independently hydrogen, an alkyl group, a haloalkyl group or other substituted alkyl groups and n and n¹ are as defined above.

In an illustrative embodiment, as may be combined with one or more of the preceding paragraphs, a class of representative non-bulky organosilicon-containing monomers includes one or more monomers of Formulas XXII-XXIV:

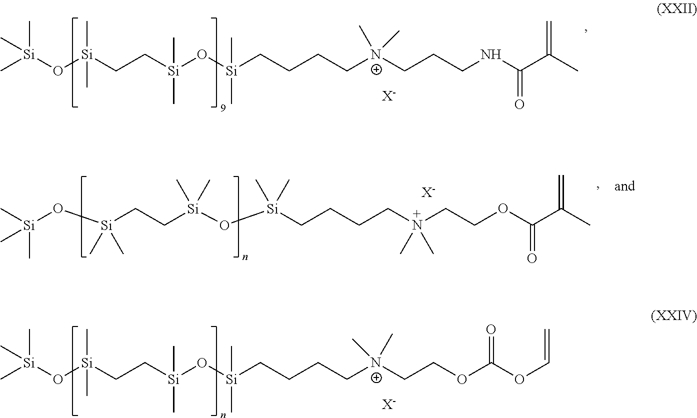

wherein n is as defined above and X⁻ is a counterion to provide an overall neutral charge.

Counterions capable of providing an overall neutral charge are well known to those of ordinary skill in the art and would include, for example, halide ions.

In an illustrative embodiment, as may be combined with one or more of the preceding paragraphs, a class of representative non-bulky organosilicon-containing monomers includes one or more monomers of Formula XXV:

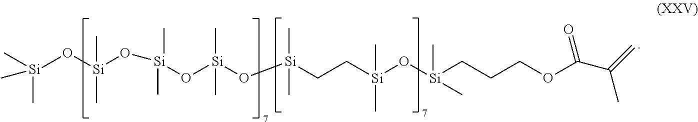

In accordance with one or more additional non-limiting illustrative embodiments, as may be combined with one or more of the preceding paragraphs, the one or more non-bulky organosilicon-containing monomers can be present in the monomeric mixture in an amount ranging from about 2 wt. % to about 40 wt. %, based on the total weight of the monomeric mixture. In some embodiments, the one or more non-bulky organosilicon-containing monomers can be present in the monomeric mixture in an amount ranging from about 3 wt. % to about 20 wt. %, based on the total weight of the monomeric mixture.

The above silicone materials are merely exemplary, and other materials for use as substrates that have been disclosed in various publications and are being continuously developed for use in contact lenses can also be used.

In one or more additional non-limiting illustrative embodiments, as may be combined with one or more of the preceding paragraphs, the monomeric mixture will further include one or more rigid gas permeable contact lens-forming comonomers having an ethylenically unsaturated reactive group. Suitable one or more rigid gas permeable contact lens-forming comonomers include, for example, one or more vinylaromatic compounds, i.e., compounds having only one vinyl group attached to an aromatic group and the di-, tri etc. vinylaromatic compounds having two or more vinyl groups attached to an aromatic group. Representative examples of vinylaromatic compounds include, but are not limited to, styrene, C₁ to C₆ alkyl-substituted styrene, silicone-containing styrene monomers and the like. Suitable C₁ to C₆ alkyl-substituted styrene compounds include, for example, 2-methyl styrene, 3-methyl styrene, 4-methyl styrene, 2,4-dimethylstyrene, 2,4-dimethyl, trimethyl styrene such as 2,4,6-trimethyl styrene, α-methyl styrene, 2,4-diisopropyl styrene and 4-tert-butyl styrene and the like. Suitable silicone-containing styrene monomers include, for example, p-styryltrimethoxysilane, styrylethyltrimethoxysilane, p-(t-butyldimethylsiloxy) styrene and the like. In an illustrative embodiment, suitable one or more rigid gas permeable contact lens-forming comonomers include a monovinylaromatic compound. In an illustrative embodiment, suitable one or more rigid gas permeable contact lens-forming comonomers include C₁ to C₆ alkyl-substituted styrene such as a tri C₁ to C₆ alkyl-substituted styrene.

In one or more additional non-limiting illustrative embodiments, as may be combined with one or more of the preceding paragraphs, suitable one or more rigid gas permeable contact lens-forming comonomers may include, for example, ethylenically unsaturated hydrophobic monomers such as non-silicone hydrophobic acrylic monomers. Suitable non-silicone hydrophobic acrylic monomers include, for example, C₁-C₁₂ alkyl (meth)acrylates such as methyl (meth)acrylate, ethyl (meth)acrylate, propyl (meth)acrylate, isopropyl (meth)acrylate, cyclohexyl (meth)acrylate, 2-ethylhexyl (meth)acrylate, isobornyl (meth)acrylate, 1-adamantyl methacrylate, N-benzylmethacrylamide and the like and mixtures thereof.

In accordance with one or more additional non-limiting illustrative embodiments, as may be combined with one or more of the preceding paragraphs, the one or more rigid gas permeable comonomers can be present in the monomeric mixture in an amount ranging from about 2 wt. % to about 25 wt. % and the one or more rigid gas permeable contact lens-forming comonomers can be present in the monomeric mixture in an amount ranging from about 5 wt. % to about 20 wt. %, based on the total weight of the monomeric mixture.

In one or more additional non-limiting illustrative embodiments, as may be combined with one or more of the preceding paragraphs, the monomeric mixtures can further include one or more additional rigid gas permeable contact lens-forming comonomers. Suitable one or more additional rigid gas permeable contact lens-forming comonomers include, for example, unsaturated carboxylic acids such as acrylic acid, methacrylic acid and the like. In an illustrative embodiment, the one or more additional rigid gas permeable contact lens-forming comonomers can be present in the monomeric mixture in an amount ranging from about 1 wt. % to about 15 wt. %, based on the total weight of the monomeric mixture.

In one or more additional non-limiting illustrative embodiments, as may be combined with one or more of the preceding paragraphs, the monomeric mixtures further include a branched crosslinking agent. Suitable branched crosslinking agents include, for example, a bi- or polyfunctional crosslinking agent. In some embodiments, a suitable branched crosslinking agent includes, for example, a branched crosslinking agent having two or more ethylenically unsaturated reactive groups. In some embodiments, a suitable branched crosslinking agent includes, for example, a branched crosslinking agent having from 2 and up to 6 ethylenically unsaturated reactive groups. In some embodiments, a suitable branched crosslinking agent includes, for example, a branched acrylate or methacrylate crosslinking agent. Suitable branched acrylate or methacrylate crosslinking agents include, for example trimethylolpropane triacrylate, pentaerythritol tetraacrylate, 1,6-hexanediol diacrylate and the like. In some embodiments, a suitable branched crosslinking agent includes, for example, a branched acrylamide crosslinking agent. Suitable branched acrylamide crosslinking agents include, for example, N,N′-methylenebisacrylamide and the like.

In some embodiments, a suitable branched crosslinking agent includes, for example, an alkyl glycol crosslinking agent having two or more ethylenically unsaturated reactive groups. In some embodiments, an alkyl glycol crosslinking agent having two or more ethylenically unsaturated reactive groups includes, for example, ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, nepentyl glycol di(meth)acrylate, polypropylene glycol di(meth)acrylate, and the like.

In some embodiments, a suitable branched crosslinking agent includes, for example, a polysiloxane represented by a structure of Formula XXVI:

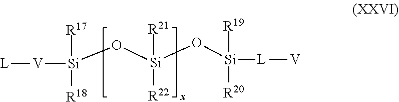

wherein each V is an independently ethylenically unsaturated reactive group and includes, by way of example, an acrylate or methacrylate-containing reactive group, R¹⁷ to R²² are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 2 to 60.

Linking group L is independently a straight or branched alkyl group, cycloalkyl group, an aryl group, an ether or polyether group, and an ester group with as defined herein.

Representative examples of ester groups for use herein include, by way of example, a carboxylic acid ester having one to 20 carbon atoms and the like.

Representative examples of ether or polyether containing groups for use herein include, by way of example, an alkyl ether, cycloalkyl ether, cycloalkylalkyl ether, cycloalkenyl ether, aryl ether, arylalkyl ether wherein the alkyl, cycloalkyl, cycloalkylalkyl, cycloalkenyl, aryl, and arylalkyl groups are as defined herein. Exemplary ether or polyether-containing groups include, by way of example, alkylene oxides, poly(alkylene oxide) s such as ethylene oxide, propylene oxide, butylene oxide, poly(ethylene oxide) s, poly(ethylene glycol) s, poly(propylene oxide) s, poly(butylene oxide) s and mixtures or copolymers thereof, an ether or polyether group of the general formula —(R²OR³)ₜ, wherein R² is a bond, a substituted or unsubstituted alkyl, cycloalkyl or aryl group as defined herein and R³ is a substituted or unsubstituted alkyl, cycloalkyl or aryl group as defined herein and tis at least 1, e.g., —CH₂CH₂OC₆H₅ and CH₂—CH₂—CH₂—O—CH₂—(CF₂)_{z}—H where z is 1 to 6, —CH₂CH₂OC₂H₅, and the like.

A representative example of a polysiloxane of Formula XXVI is as follows:

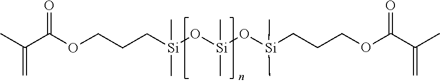

wherein n is from 5 to 100.

Another representative example of a polysiloxane of Formula XXVI is as follows:

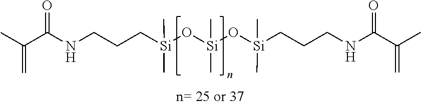

In some embodiments, a suitable branched crosslinking agent includes, for example, a polysiloxane copolymer represented by a structure of Formula XXVII:

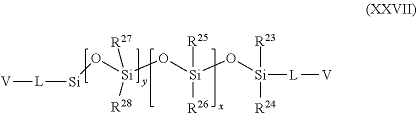

wherein each V is an independently ethylenically unsaturated reactive group and includes, by way of example, an acrylate, methacrylate or carbamate-containing reactive group, R²³, R²⁴, R²⁵, R²⁶, and R²⁷ are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, R²⁸ is a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, a substituted or unsubstituted C₇-C₃₀ arylalkyl group, and a hydroxyl C₁-C₃₀ alkyl group, L is independently a linking group, and x and y are independently from 1 to 60 where x+y is 2 to 100.

A representative example of a polysiloxane copolymer of Formula XXVII is as follows:

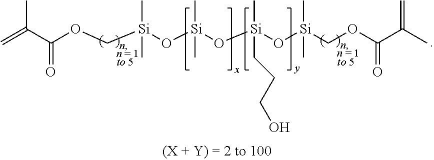

A representative example of a polysiloxane copolymer of Formula XXVII is as follows:

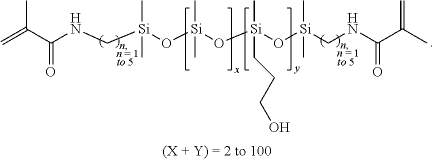

A representative example of a polysiloxane copolymer of Formula XXVII is as follows:

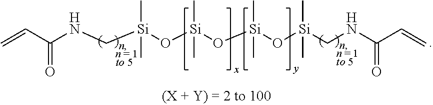

A representative example of a polysiloxane copolymer of Formula XXVII is as follows:

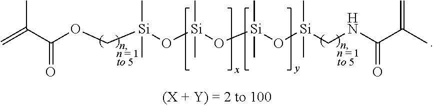

A representative example of a polysiloxane copolymer of Formula XXVII is as follows:

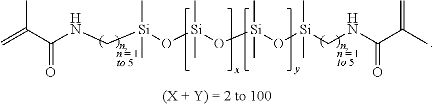

A representative example of a polysiloxane copolymer of Formula XXVII is as follows:

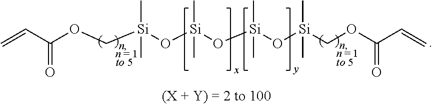

Methods for making the polysiloxanes described herein are well known and within the purview of one skilled in the art. In addition, the polysiloxanes are also commercially available from such sources as, for example, Gelest, Silar, Shin-Etsu, Momentive and Siltech.

In some embodiments, a suitable branched crosslinking agent includes, for example, a cyclosiloxane represented by a structure of Formula XXVIII:

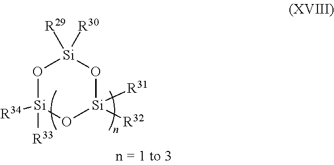

wherein R²⁹, R³⁰, R³¹, R³², R³³ and R³⁴ are independently an ethylenically unsaturated reactive group and include, by way of example, a, vinyl, an acrylate, methacrylate or carbamate-containing reactive group or a C₁ to C₆ styrene group, and a straight or branched, substituted or unsubstituted C₁-C₃₀ alkyl group, where at least two of R²⁹, R³⁰, R³¹, R³², R³³ and R³⁴ are an ethylenically unsaturated reactive group.

A representative example of a cyclosiloxane of Formula XXVIII is as follows:

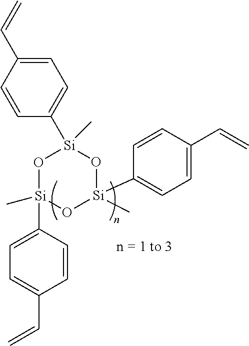

A representative example of a cyclosiloxane of Formula XXVIII is as follows:

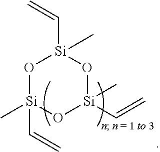

A representative example of a cyclosiloxane of Formula XXVIII is as follows:

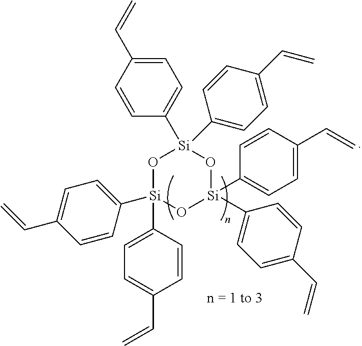

A representative example of a cyclosiloxane of Formula XXVIII is as follows:

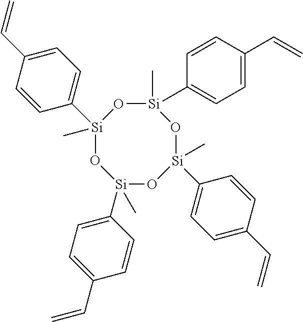 [SMILES: C=Cc1ccc([Si]2(C)O[Si](C)(c3ccc(C=C)cc3)O[Si](C)(c3ccc(C=C)cc3)O[Si](C)(c3ccc(C=C)cc3)O2)cc1]

In some embodiments, a suitable branched crosslinking agent includes, for example, an organosilicone represented by a structure of Formula XXIX:

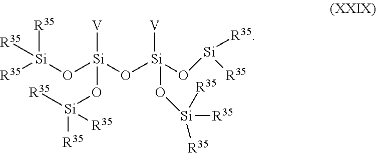

wherein each V is an independently ethylenically unsaturated reactive group and includes, by way of example, an acrylate, methacrylate or carbamate-containing reactive group, and R³⁵ is independently a straight or branched, substituted or unsubstituted C₁-C₆ alkyl group.

A representative example of an organosilicone of Formula XXIX is as follows:

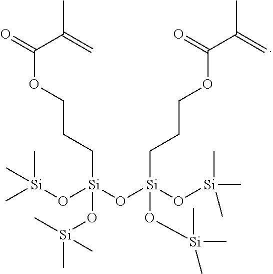 [SMILES: C=C(C)C(=O)OCCC[Si](O[Si](C)(C)C)(O[Si](C)(C)C)O[Si](CCCOC(=O)C(=C)C)(O[Si](C)(C)C)O[Si](C)(C)C]

In some embodiments, the branched crosslinking agent can be present in the monomeric mixture in an amount ranging from about 2 wt. % to about 30 wt. %, based on the total weight of the monomeric mixture. In some embodiments, the branched crosslinking agent can be present in the monomeric mixture in an amount ranging from about 3 wt. % to about 20 wt. %, based on the total weight of the monomeric mixture.

In accordance with one or more additional non-limiting illustrative embodiments, as may be combined with one or more of the preceding paragraphs, the monomeric mixtures disclosed herein may include one or more additional components. For example, when producing the rigid gas-permeable contact lenses according to the illustrative embodiments, the monomeric mixture may further include a wetting monomer; and optionally other agents such as strengthening agents or UV absorbing or dye monomers. The wetting agents can include those wetting agents known in the prior art for making rigid gas permeable materials. The content of the crosslinking agent is chosen to provide a dimensionally stable lens material resistant to breakage and stress crazing. The amount of wetting monomer used is adjusted within limits to provide sufficient wetting characteristics so as to maintain a stable tear film while at the same time keeping a sufficiently low water content, e.g., a polymer system containing less than about 5 wt. % water.

In accordance with one or more additional non-limiting illustrative embodiments, as may be combined with one or more of the preceding paragraphs, the monomeric mixtures disclosed herein may be polymerized by free radical polymerization by exposing the mixture to heat and/or radiation, e.g., ultraviolet light (UV), visible light, or high energy radiation, to produce rigid gas permeable contact lenses according to conventional methods. A polymerization initiator may be included in the monomeric mixture to facilitate the polymerization step. Suitable free radical thermal polymerization initiators include, for example, organic peroxides such as, for example, acetal peroxide, lauroyl peroxide, decanoyl peroxide, stearoyl peroxide, benzoyl peroxide, tertiarylbutyl peroxypivalate, peroxydicarbonate, and the like and mixtures thereof. Suitable UV initiators include, for example, benzoin methyl ether, benzoin ethyl ether, Darocure 1173, 1164, 2273, 1116, 2959, 3331 (EM Industries) and Igracure 651 and 184 (Ciba-Geigy), and the like and mixtures thereof. Generally, the initiator will be employed in the monomeric mixture at a concentration at about 0.1 to about 5 wt. %, based on the total weight of the monomeric mixture.

In an illustrative embodiment, in producing the rigid gas permeable contact lenses of the illustrative embodiments, the monomeric mixture may be polymerized in tubes to provide rod-shaped articles, which are then cut into buttons. The buttons may then be lathed into rigid gas permeable contact lenses. Alternately, the rigid gas permeable contact lenses may be cast directly in molds from the monomeric mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the monomeric mixture to a mold, and spinning the mold in a controlled manner while exposing the monomeric mixture to a radiation source such as UV light. Static casting methods involve charging the monomeric mixture between two mold sections, one mold section shaped to form the anterior lens surface and the other mold section shaped to form the posterior lens surface, and curing the monomeric mixture while it is retained in the mold assembly to form a lens, for example, by free radical polymerization of the monomeric mixture. Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a monomeric mixture is cured by spincasting in a mold to form a shaped article having an anterior lens surface and a relatively large thickness, and the posterior surface of the cured spincast article is subsequently lathed to provide a contact lens having the desired thickness and posterior lens surface.

When polymerizing the monomeric mixture by the thermal technique discussed above, a polymeric resin or metal material that is capable of withstanding high temperatures, i.e., thermally stable, should be employed as a contact lens mold. For example, in injection molding, the resin should have a heat deflection temperature of at least 350° C. and a hardness of at least 100 on the Rockwell Hardness Scale (M scale). Suitable resins include, but are not limited to, engineering plastics based on polyetherimide resins (e.g., ULTEM™ available from General Electric Co., Polymers Product Dept.); polyamide-imide plastics (e.g., TORLON available from Amoco Performance Products); polyphenylene sulfide plastics (e.g., RYTON™ available from Phillips Petroleum Co.); polysulfone and polyarylsulfone plastics (e.g., UDEL™ and RADEL™ available from Amoco Performance Products); polythalamide plastics (e.g., AMODEL available from Amoco Performance Products); polyketone plastics (e.g., KADEL™ available from Amoco Performance Products); various liquid crystal polymer resins (e.g., XYDAR™ available from Amoco Performance Products) and the like.

As one skilled in the art will readily understand, rigid gas permeable contact lenses are typically manufactured by lathing at least one surface from a blank of the resulting polymerization product, and in many cases, by lathing both the front and back surfaces as well as the diameter from a cylindrical button. Therefore, it is advantageous that the resulting polymerization product is not only optically clear, but also machinable. Accordingly, in an illustrative embodiment, the rigid gas permeable contact lenses disclosed herein can have a Shore D hardness of at least about 55. In some embodiments, the rigid gas permeable contact lenses disclosed herein can have a Shore D hardness of at least about 60. In some embodiments, the rigid gas permeable contact lenses disclosed herein can have a Shore D hardness of at least about 65. In some embodiments, the rigid gas permeable contact lenses disclosed herein can have a Shore D hardness of at least about 70. In some embodiments, the rigid gas permeable contact lenses disclosed herein can have a Shore D hardness of no more than about 85. Any combination of the forgoing ranges is contemplated herein.

In accordance with one or more additional non-limiting illustrative embodiments, as may be combined with one or more of the preceding paragraphs, the rigid gas permeable contact lenses disclosed herein can have an oxygen permeability (i.e., Dk) of at least about 90 barrers. In some embodiments, the rigid gas permeable contact lenses disclosed herein can have an oxygen permeability of at least about 100 barrers. In some embodiments, the rigid gas permeable contact lenses disclosed herein can have an oxygen permeability of at least about 120 barrers. In some embodiments, the rigid gas permeable contact lenses disclosed herein can have an oxygen permeability of no more than 150 barrers. In some embodiments, the rigid gas permeable contact lenses disclosed herein can have an oxygen permeability of no more than 250 barrers. Any combination of the forgoing ranges is contemplated herein.

Any combination of the forgoing ranges of oxygen permeability and hardness is contemplated herein.

In accordance with one or more additional non-limiting illustrative embodiments, as may be combined with one or more of the preceding paragraphs, the rigid gas permeable contact lenses disclosed herein are free of any per- and polyfluoroalkyl substances (PFAS) materials.

The lens may then be transferred to individual lens packages containing a buffered saline solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

As one skilled in the art will readily appreciate other steps may be included in the molding and packaging process described above. Such other steps can include, for example, coating the formed lens, surface treating the lens during formation (e.g., via mold transfer), inspecting the lens, discarding defective lenses, cleaning the mold halves, reusing the mold halves, and the like and combinations thereof.

The following examples are provided to enable one skilled in the art to practice the invention and are merely illustrative. The examples should not be read as limiting the scope of the invention as defined in the claims.

In the examples, the following abbreviation is used.

Ma2D37: A compound having the structure:

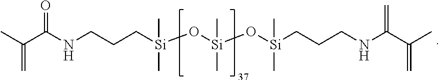

M1EDS6: A compound having the following structure and available from Gelest:

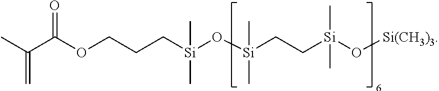

MCR-M11: A compound having the structure:

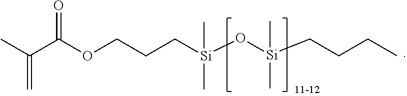

X-22-1666C: a silicone monomer represented by the following structure and available from Shin-Etsu:

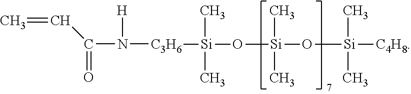

TRIS: Tris(trimethylsiloxy) silylpropyl methacrylate.

BMPTTRISD: A compound represented by the following structure:

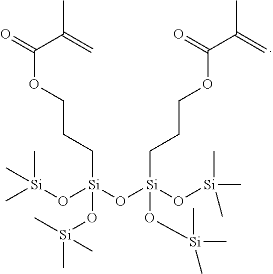 [SMILES: C=C(C)C(=O)OCCC[Si](O[Si](C)(C)C)(O[Si](C)(C)C)O[Si](CCCOC(=O)C(=C)C)(O[Si](C)(C)C)O[Si](C)(C)C]

D4Me, Vi: A compound represented by the following structure:

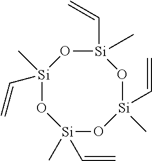 [SMILES: C=C[Si]1(C)O[Si](C)(C=C)O[Si](C)(C=C)O[Si](C)(C=C)O1]

UV416:2-(4-Benzoyl-3-hydroxyphenoxy)ethyl acrylate.

Luperox256:2,5-Dimethyl-2,5-Di-(2-ethylhexanoylperoxy)-Hexane; A compound represented by the following structure:

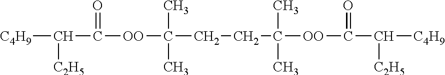

AIBN: Azo bis-isobutylnitrile (Vazo™ 64).

Various polymerization products were formed as discussed below and characterized by standard testing procedures such as:

Oxygen permeability (also referred to as Dk) is determined by the following procedure. Other methods and/or instruments may be used as long as the oxygen permeability values obtained therefrom are equivalent to the described method. The oxygen permeability of silicone hydrogels is measured by the polarographic method (ANSI Z80.20-1998) using an 02 Permeometer Model 201T instrument (Createch, Albany, Calif. USA) having a probe comprising a central, circular gold cathode at its end and a silver anode insulated from the cathode. Measurements are taken only on pre-inspected pinhole-free, flat silicone hydrogel film samples of three different center thicknesses ranging from 150 to 600 microns. Center thickness measurements of the film samples may be measured using a Rehder ET-1 electronic thickness gauge. Generally, the film samples have the shape of a circular disk. Measurements are taken with the film sample and probe immersed in a bath comprising circulating phosphate buffered saline (PBS) equilibrated at 35° C.+/−0.2°. Prior to immersing the probe and film sample in the PBS bath, the film sample is placed and centered on the cathode premoistened with the equilibrated PBS, ensuring no air bubbles or excess PBS exists between the cathode and the film sample, and the film sample is then secured to the probe with a mounting cap, with the cathode portion of the probe contacting only the film sample. For silicone hydrogel films, it is frequently useful to employ a Teflon polymer membrane, e.g., having a circular disk shape, between the probe cathode and the film sample. In such cases, the Teflon membrane is first placed on the pre-moistened cathode, and then the film sample is placed on the Teflon membrane, ensuring no air bubbles or excess PBS exists beneath the Teflon membrane or film sample. Once measurements are collected, only data with a correlation coefficient value (R2) of 0.97 or higher should be entered into the calculation of Dk value. At least two Dk measurements per thickness, and meeting R2 value, are obtained.

Using known regression analyses, oxygen permeability (Dk) is calculated from the film samples having at least three different thicknesses. Any film samples hydrated with solutions other than PBS are first soaked in purified water and allowed to equilibrate for at least 24 hours, and then soaked in PBS and allowed to equilibrate for at least 12 hours. The instruments are regularly cleaned and regularly calibrated using RGP standards. Upper and lower limits are established by calculating a +/−8.8% of the Repository values established by William J. Benjamin, et al., The Oxygen Permeability of Reference Materials, Optom V is Sci 7 (12s): 95 (1997), the disclosure of which is incorporated herein in its entirety.

Shore D hardness may be measured according to ASTM D2240, employing a Shore D durometer on disk samples. Preferably, for both hardness methods, the samples are preconditioned by storing the samples for at least 40 hours in a chamber with 50% controlled humidity, such as by the method of ASTM E104-85.

### Examples 1-4

A monomeric mixture was made by mixing the following components, listed in Table 1 at amounts per weight.

TABLE 1

| | Ex. 1 | Ex. 2 | Ex. 3 | Ex. 4 |
|---|---|---|---|---|
| Formulation | | | | |
| TRIS-MA | 63 | 63 | 63 | 67.5 |
| Neopentyl Glycol | 12.1 | 12.1 | 12.1 | 15 |
| Dimethacrylate | | | | |
| Ma2D37 | 4.5 | 4.5 | 4.5 | — |
| UV416 | 0.5 | 0.5 | — | — |
| 2,4,6-trimethylstyrene | 19.8 | 0 | 5.94 | 7 |
| Isobornyl methacrylate | 0 | 19.8 | 13.86 | 10.4 |
| Luperox 256 | 0.1 | 0.1 | 0.1 | 0.1 |
| Total | 100 | 100 | 100 | 100 |
| Properties | | | | |
| Hardness | 75 | 73 | 73 | 74 |
| (Shore D) | | | | |
| Dk | 100 | 95 | 98 | 102 |

The monomeric mixture was prepared by mixing the components in a beaker with a stir bar until the solution was homogeneous. The solution was filtrated through a PTFE membrane (0.22 μm) with a prefilter of glass fiber (10 to 1 μm). The filtrate was then cast into a polypropylene tube. The solution in the tube was degassed and refilled with nitrogen three times. The degassed tube was then transferred to a thermal oven for a thermal curing process.

The cured RGP rod was removed from the polypropylene tube after the curing process. In some embodiments, rods were passed through gamma radiation. The rods were then transferred to an oven at 100° C. for at least 12 hours for thermal annealing. The annealed RGP rod was then ready for lathe process. The rod was cut into several buttons. The buttons were lathed and polished into RGP lenses.

### Examples 5-8

A monomeric mixture was made by mixing the following components, listed in Table 2 at amounts per weight.

TABLE 2

| | Ex. 5 | Ex. 6 | Ex. 7 | Ex. 8 |
|---|---|---|---|---|
| Formulation | | | | |
| TRISMA | 62.9 | 62.9 | 62.9 | 63.3 |
| Neopentyl Glycol | 12.1 | 12.1 | 12.1 | 12.1 |
| Dimethacrylate | | | | |
| Ma2D37 | 4.5 | 4.5 | 4.5 | 4.5 |
| UV416 | 0.5 | 0.5 | 0.5 | — |
| 2,4,6-trimethylstyrene | 19.8 | 0 | 5.94 | 6.0 |
| Isobornyl methacrylate | 0 | 19.8 | 13.86 | 13.90 |
| Vazo 64 | 0.2 | 0.2 | 0.2 | 0.2 |
| Total | 100 | 100 | 100 | 100 |
| Properties | | | | |
| Hardness | 76 | 76 | 76 | 75 |
| (Shore D) | | | | |
| Dk | 121 | 105 | 97 | 95 |

The monomeric mixture was prepared by mixing the components in a beaker with a stir bar until the solution was homogeneous. The solution was filtrated through a PTFE membrane (0.22 μm) with a prefilter of glass fiber (10 to 1 μm). The filtrate was then cast into a polypropylene tube. The solution in the tube was degassed and refilled with nitrogen three times. The degassed tube was then transferred to a thermal oven for a thermal curing process.

The cured RGP rod was removed from the polypropylene tube after the curing process. In some embodiments, rods were passed through gamma radiation. The rods were then transferred to an oven at 100° C. for at least 12 hours for thermal annealing. The annealed RGP rod was then ready for lathe process. The rod was cut into several buttons. The buttons were lathed and polished into RGP lenses.

### Examples 9-14

A monomeric mixture was made by mixing the following components, listed in Table 3 at amounts per weight.

TABLE 3

| | Ex. 9 | Ex. 10 | Ex. 11 | Ex. 12 | Ex. 13 | Ex. 14 |
|---|---|---|---|---|---|---|
| Formulation | | | | | | |
| TRISMA | 50 | 50 | 50 | 50 | 50 | 50 |
| Neopentyl Glycol | 15.6 | 15.6 | 15.6 | 15.6 | 15.6 | 15.6 |
| Dimethacrylate | | | | | | |
| M1EDS6 | 14 | — | — | 14 | — | — |
| MCR-M11 | — | 14 | — | — | 14 | — |
| X-22-1666c | — | — | 14 | — | — | 14 |
| UV416 | 0.5 | 0.5 | 0.5 | 0.5 | 0.5 | 0.5 |
| 2,4,6- | 19.8 | 19.8 | 19.8 | — | — | — |
| trimethylstyrene | | | | | | |
| Isobornyl | — | — | — | 19.8 | 19.8 | 19.8 |
| methacrylate | | | | | | |
| Vazo 64 | 0.2 | 0.2 | 0.2 | 0.2 | 0.2 | 0.2 |
| Total | 100.1 | 100.1 | 100.1 | 100.1 | 100.1 | 100.1 |
| Properties | | | | | | |
| Hardness | 71 | 72 | 72 | 71 | 72 | 72 |
| (Shore D) | | | | | | |
| Dk | 93 | 95 | 121 | 94 | 110 | 105 |

The monomeric mixture was prepared by mixing the components in a beaker with a stir bar until the solution was homogeneous. The solution was filtrated through a PTFE membrane (0.22 μm) with a prefilter of glass fiber (10 to 1 μm). The filtrate was then cast into a polypropylene tube. The solution in the tube was degassed and refilled with nitrogen three times. The degassed tube was then transferred to a thermal oven for a thermal curing process.

The cured RGP rod was removed from the polypropylene tube after the curing process. In some embodiments, rods were passed through gamma radiation. The rods were then transferred to an oven at 100° C. for at least 12 hours for thermal annealing. The annealed RGP rod was then ready for lathe process. The rod was cut into several buttons. The buttons were lathed and polished into RGP lenses.

### Examples 15-22

A monomeric mixture is made by mixing the following components, listed in Table 4 at amounts per weight.

TABLE 4

| Formulation | Ex. 15 | Ex. 16 | Ex. 17 | Ex. 18 | Ex. 19 | Ex. 20 | Ex. 21 | Ex. 22 |
|---|---|---|---|---|---|---|---|---|
| TRISMA | 63 | 63 | 50 | 50 | 50 | 50 | 50 | 50 |
| Neopentyl Glycol | 8.1 | 12.1 | 11.6 | 11.6 | 11.6 | 11.6 | 11.6 | 11.6 |
| Dimethacrylate | | | | | | | | |
| BMPTTRISD | 4.0 | 4.0 | 4.0 | 4.0 | 4.0 | 4.0 | 4.0 | 4.0 |
| Ma2D37 | 4.5 | 4.5 | — | — | — | — | — | — |
| MCR-M11 | — | — | 14 | 14 | — | — | — | — |
| X-22-1666c | — | — | — | — | 14 | 14 | — | — |
| M1EDS6 | — | — | — | — | — | — | 14 | 14 |
| UV416 | 0.5 | 0.5 | 0.5 | 0.5 | 0.5 | 0.5 | 0.5 | 0.5 |
| 2,4,6-trimethylstyrene | 19.8 | 0 | 19.8 | — | 19.8 | — | 19.8 | — |
| Isobornyl methacrylate | 0 | 19.8 | — | 19.8 | — | 19.8 | — | 19.8 |
| Vazo 64 | 0.2 | 0.2 | 0.2 | 0.2 | 0.2 | 0.2 | 0.2 | 0.2 |
| Total | 100.1 | 100.1 | 100.1 | 100.1 | 100.1 | 100.1 | 100.1 | 100.1 |

The monomeric mixture is prepared by mixing the components in a beaker with a stir bar until the solution is homogeneous. The solution is filtrated through a PTFE membrane (0.22 μm) with a prefilter of glass fiber (10 to 1 μm). The filtrate is then cast into a polypropylene tube. The solution in the tube was degassed and refilled with nitrogen three times. The degassed tube is then transferred to a thermal oven for a thermal curing process.

The cured RGP rod is removed from the polypropylene tube after the curing process. In some embodiments, rods are passed through gamma radiation. The rods are then transferred to an oven at 100° C. for at least 12 hours for thermal annealing. The annealed RGP rod is then ready for lathe process. The rod is cut into several buttons. The buttons are lathed and polished into RGP lenses.

### Examples 23-30

A monomeric mixture is made by mixing the following components, listed in Table 5 at amounts per weight.

TABLE 5

| Formulation | Ex. 23 | Ex. 24 | Ex. 25 | Ex. 26 | Ex. 27 | Ex. 28 | Ex. 29 | Ex. 30 |
|---|---|---|---|---|---|---|---|---|
| TRISMA | 63 | 63 | 50 | 50 | 50 | 50 | 50 | 50 |
| Neopentyl Glycol | 8.1 | 12.1 | 11.6 | 11.6 | 11.6 | 11.6 | 11.6 | 11.6 |
| Dimethacrylate | | | | | | | | |
| D4Me, Vi | 4.0 | 4.0 | 4.0 | 4.0 | 4.0 | 4.0 | 4.0 | 4.0 |
| Ma2D37 | 4.5 | 4.5 | — | — | — | — | — | — |
| MCR-M11 | — | — | 14 | 14 | — | — | — | — |
| X-22-1666c | — | — | — | — | 14 | 14 | — | — |
| M1EDS6 | — | — | — | — | — | — | 14 | 14 |
| UV416 | 0.5 | 0.5 | 0.5 | 0.5 | 0.5 | 0.5 | 0.5 | 0.5 |
| 2,4,6-trimethylstyrene | 19.8 | 0 | 19.8 | — | 19.8 | — | 19.8 | — |
| Isobornyl methacrylate | 0 | 19.8 | — | 19.8 | — | 19.8 | — | 19.8 |
| Vazo 64 | 0.2 | 0.2 | 0.2 | 0.2 | 0.2 | 0.2 | 0.2 | 0.2 |
| Total | 100.1 | 100.1 | 100.1 | 100.1 | 100.1 | 100.1 | 100.1 | 100.1 |

The monomeric mixture is prepared by mixing the components in a beaker with a stir bar until the solution is homogeneous. The solution is filtrated through a PTFE membrane (0.22 μm) with a prefilter of glass fiber (10 to 1 μm). The filtrate is then cast into a polypropylene tube. The solution in the tube was degassed and refilled with nitrogen three times. The degassed tube is then transferred to a thermal oven for a thermal curing process.

The cured RGP rod is removed from the polypropylene tube after the curing process. In some embodiments, rods are passed through gamma radiation. The rods are then transferred to an oven at 100° C. for at least 12 hours for thermal annealing. The annealed RGP rod is then ready for lathe process. The rod is cut into several buttons. The buttons are lathed and polished into RGP lenses.

### Comparative Examples a, B and C

A monomeric mixture was made by mixing the following components, listed in Table 6 at amounts per weight.

TABLE 6

| | Comp. | Comp. | Comp. |
|---|---|---|---|
| | Ex. A | Ex. B | Ex. C |
| Formulation | | | |
| poly(TRISMA-co- | 80 | 80 | — |
| HEA-IEM) | | | |
| Tris | — | — | 69.1 |
| Neopentyl | — | — | 11.1 |
| Glycoldimethacrylate | | | |
| Methyl Methacrylate | — | 20 | 15 |
| Trimethyl Styrene | 10 | — | 5 |
| Methacrylic acid | 10 | — | — |
| Luprox 256 | 0.1 | 0.1 | 0.1 |
| Total Part | 100.1 | 100.1 | 100.1 |
| Properties | | | |
| Hardness | 72-73 | 76 | 75-76 |
| (Shore D) | | | |
| Dk | 100 | 103 | 85 |

The monomeric mixture was prepared by mixing monomers and poly(TRISMA-CO-HEA-IEM) with a speed mixer until the solution was homogeneous. The solution was filtrated through a PVDF membrane (0.45 μm) with a prefilter of glass fiber (10 to 1 μm). The filtrate was then transferred to cylindrical shaped polypropylene tubes and degassed followed by purging with nitrogen. It was then thermally cured.

The cured RGP rod was removed from the polypropylene tube after the curing process. The rod was transferred to an oven at 100° C. for at least 12 hours for thermal annealing. The annealed RGP rod was then ready for lathe process. The rod was cut into several buttons. The buttons were lathed and polished into RGP lenses. The RGP lenses were determined to be hazy and contained rings.

### Example 31

### Preparation of a Rigid Gas Permeable Prepolymer.

Into an air free flask was placed 3-[tris(trimethylsiloxy)silyl]propyl methacrylate (100 g, 80 mole %), 2-hydroxyl ethyl acrylate (6.86 g, 20 mole %), mercaptoethanol (0.462 g, 2 mole %) and AIBN (0.098 g, 0.202 mole %) and dissolved in anhydrous ethyl acetate (170 mL). The flask was purged with nitrogen for 1 hour, closed and then placed in a preheated oil bath at 60° C. for 8 hours. The temperature was increased to 65° C. and stirring was continued at this temperature for a total of 24 hours. The reaction mixture was then cooled to 25° C. and followed by the addition of dibutyltin dilaurate (0.1 g) and 2-isocyantoethyl methacrylate (9.618 g). The reaction mixture was stirred for 12 hours at 25° C. Acetonitrile (100 mL) was then added to this reaction mixture and allowed to settle down for 2 hours for phase separation. The upper layer was decanted (265 mL solvent decanted) to leave a gummy mass. Ethyl acetate (20 mL) and acetonitrile (100 mL) was then added to this gummy mass and allowed to settle down for 2 hours. The upper layer was decanted and the left over mass was dried to yield a bulky long chain silicone monomer characterized as poly(TRISMA-co-HEA-IEM) as shown in below reaction scheme:

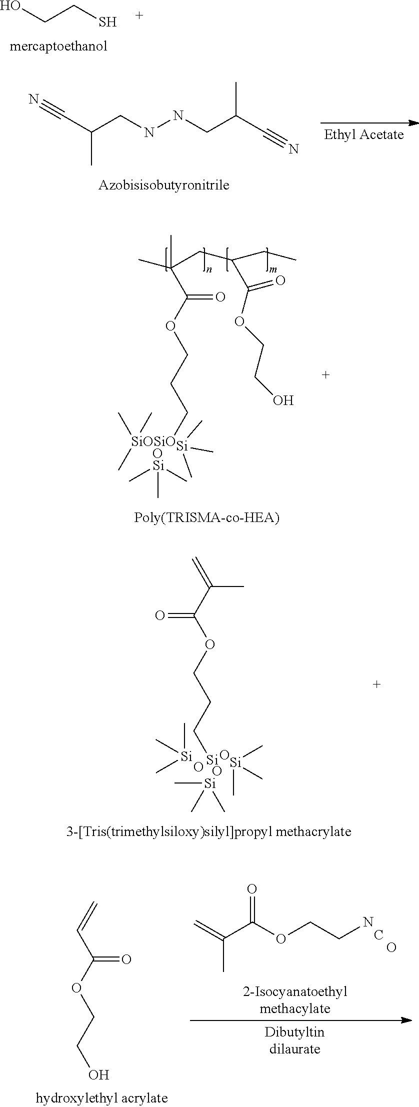

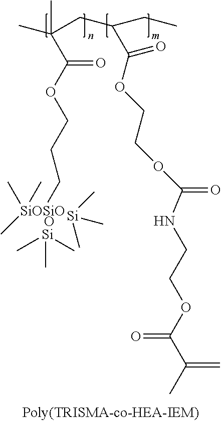

where m is 10 and n is 40.

According to an aspect of the present disclosure, a rigid gas permeable contact lens comprising a polymerization product of a monomeric mixture comprises:
(a) a bulky siloxane monomer or prepolymer having an ethylenically unsaturated reactive group;
(b) a non-bulky organosilicon-containing monomer having an ethylenically unsaturated reactive group,
(c) a rigid gas permeable contact lens-forming comonomer, and
(d) a branched cross-linking agent.

In non-limiting illustrative embodiments, as may be combined with one or more of the preceding paragraphs, the bulky siloxane monomer having an ethylenically unsaturated reactive group is a bulky polysiloxanylalkyl (meth)acrylic monomer represented by a structure of Formula I:

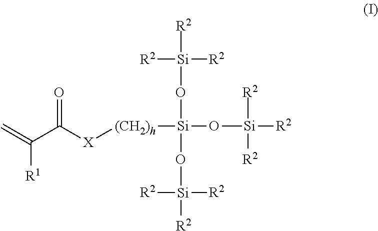

wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure:

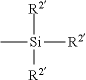

wherein each R²′ independently denotes an alkyl radical or a phenyl radical; and h is 1 to 10; or a bulky siloxane monomer represented by a structure of Formula II:

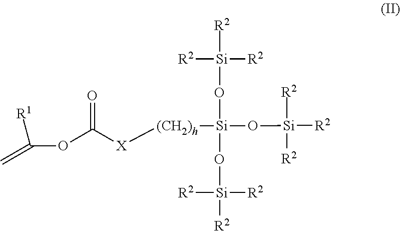

wherein X denotes —NR³— wherein R³ denotes hydrogen or a C₁-C₄ alkyl; R¹ denotes hydrogen or methyl; each R¹⁸ independently denotes an alkyl radical, a phenyl radical or a group represented by the following structure:

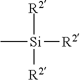

wherein each R²′ independently denotes an alkyl radical or a phenyl radical; and his 1 to 10.

In non-limiting illustrative embodiments, as may be combined with one or more of the preceding paragraphs, the non-bulky organosilicon-containing monomer having the ethylenically unsaturated reactive group is represented by the following structure:

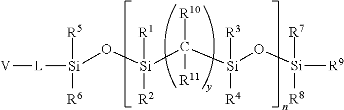

wherein V is an ethylenically unsaturated reactive group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure:

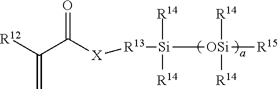

wherein R¹² is H or methyl; X is O or NR¹⁶, wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C to C₄ alkyl; and a is 2 to 50.

In non-limiting illustrative embodiments, as may be combined with one or more of the preceding paragraphs, the one or more rigid gas permeable contact lens-forming comonomers comprise one or more vinylaromatic compounds, one or more alkyl (meth)acrylates or both.

In non-limiting illustrative embodiments, as may be combined with one or more of the preceding paragraphs, the one or more vinylaromatic compounds comprise one or more of styrene and a C₁ to C₆ alkyl-substituted styrene, and the one or more alkyl (meth)acrylates comprise one or more C₁ to C₁₂ alkyl (meth)acrylates.

In non-limiting illustrative embodiments, as may be combined with one or more of the preceding paragraphs, the C₁ to C₆ alkyl-substituted styrene is a tri C₁ to C₆ alkyl-substituted styrene.

In non-limiting illustrative embodiments, as may be combined with one or more of the preceding paragraphs, the branched crosslinking agent comprises a branched crosslinking agent having two or more ethylenically unsaturated reactive groups.

In non-limiting illustrative embodiments, as may be combined with one or more of the preceding paragraphs, the branched crosslinking agent comprises a branched crosslinking agent having two to about six ethylenically unsaturated reactive groups.

In non-limiting illustrative embodiments, as may be combined with one or more of the preceding paragraphs, the branched crosslinking agent comprises an alkyl glycol crosslinking agent having two or more ethylenically unsaturated reactive groups.

In non-limiting illustrative embodiments, as may be combined with one or more of the preceding paragraphs, the alkyl glycol crosslinking agent having two or more ethylenically unsaturated reactive groups is ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, nepentyl glycol di(meth)acrylate, polypropylene glycol di(meth)acrylate, or mixtures thereof.

In non-limiting illustrative embodiments, as may be combined with one or more of the preceding paragraphs, the branched crosslinking agent comprises a polysiloxane represented by the following structure:

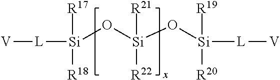

wherein each V is an independently ethylenically unsaturated reactive group, R¹⁷ to R²² are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 2 to 60.

In non-limiting illustrative embodiments, as may be combined with one or more of the preceding paragraphs, the branched crosslinking agent comprises a polysiloxane copolymer represented by the following structure:

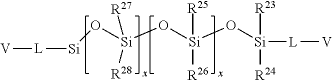

wherein each V is an independently ethylenically unsaturated reactive group, R²³, R²⁴, R²⁵, R²⁶, and R²⁷ are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, R²⁸ is a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, a substituted or unsubstituted C₇-C₃₀ arylalkyl group, and a hydroxyl C₁-C₃₀ alkyl group, L is independently a linking group, and x and y are independently from 1 to 60 where x+y is 2 to 100.

In non-limiting illustrative embodiments, as may be combined with one or more of the preceding paragraphs, the branched crosslinking agent comprises a cyclosiloxane represented by the following structure:

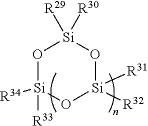

wherein R²⁹, R³⁰, R³¹, R³², R³³ and R³⁴ are independently an ethylenically unsaturated reactive group, and a straight or branched, substituted or unsubstituted C₁-C₃₀ alkyl group, where at least two of R²⁹, R³⁰, R³¹, R³², R³³ and R³⁴ are an ethylenically unsaturated reactive group.

In non-limiting illustrative embodiments, as may be combined with one or more of the preceding paragraphs, the branched crosslinking agent comprises an organosilicone represented by the following structure:

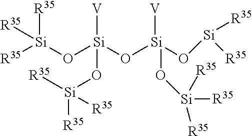

wherein each V is an independently ethylenically unsaturated reactive group, and R³⁵ is independently a straight or branched, substituted or unsubstituted C₁-C₆ alkyl group.

In non-limiting illustrative embodiments, as may be combined with one or more of the preceding paragraphs, the monomeric mixture comprises:
(a) about 30 wt. % to about 75 wt. %, based on the total weight of the monomeric mixture, of the bulky siloxane monomer or prepolymer having the ethylenically unsaturated reactive group,
(b) about 2 wt. % to about 40 wt. %, based on the total weight of the monomeric mixture, of the non-bulky organosilicon-containing monomer having the ethylenically unsaturated reactive group,
(c) about 2 wt. % to about 25 wt. %, based on the total weight of the monomeric mixture, of the rigid gas permeable contact lens-forming comonomer, and
(d) about 2 wt. % to about 30 wt. %, based on the total weight of the monomeric mixture, of the branched cross-linking agent.

In non-limiting illustrative embodiments, as may be combined with one or more of the preceding paragraphs, the monomeric mixture is free of any per- and polyfluoroalkyl substances (PFAS) materials.

In non-limiting illustrative embodiments, as may be combined with one or more of the preceding paragraphs, the rigid gas permeable contact lens has one or more of an oxygen permeability of at least about 90 barrers and up to 250 barrers and a Shore D hardness of from about 55 to about 80.

In non-limiting illustrative embodiments, as may be combined with one or more of the preceding paragraphs, the rigid gas permeable contact lens has an oxygen permeability of from about 90 barrers and up to 150 barrers and a Shore D hardness of from about 65 to about 80.

According to another aspect of the present disclosure, a method for making a rigid gas permeable contact lens comprises:
(a) curing a monomeric mixture in a mold to form a rigid gas permeable contact lens, the monomeric mixture comprising:
(i) a bulky siloxane monomer or prepolymer having an ethylenically unsaturated reactive group,
(ii) a non-bulky organosilicon-containing monomer having an ethylenically unsaturated reactive group,
(iii) a rigid gas permeable contact lens-forming comonomer, and
(iv) a branched cross-linking agent, and
(b) releasing the rigid gas permeable contact lens from the mold.

In non-limiting illustrative embodiments, as may be combined with one or more of the preceding paragraphs, the bulky siloxane monomer having an ethylenically unsaturated reactive group is a bulky polysiloxanylalkyl (meth)acrylic monomer represented by a structure of Formula I:

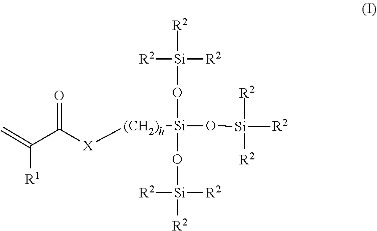

wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure:

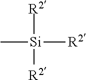

wherein each R²′ independently denotes an alkyl radical or a phenyl radical; and h is 1 to 10; or a bulky siloxane monomer represented by a structure of Formula II:

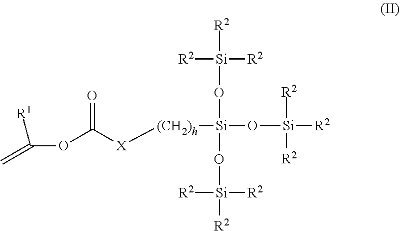

wherein X denotes —NR³— wherein R³ denotes hydrogen or a C₁-C₄ alkyl; R¹ denotes hydrogen or methyl; each R¹⁸ independently denotes an alkyl radical, a phenyl radical or a group represented by the following structure:

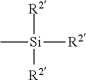

wherein each R²′ independently denotes an alkyl radical or a phenyl radical; and h is 1 to 10.

In non-limiting illustrative embodiments, as may be combined with one or more of the preceding paragraphs, the non-bulky organosilicon-containing monomer having the ethylenically unsaturated reactive group is represented by the following structure:

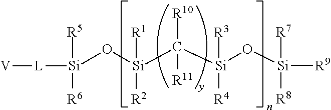

wherein V is an ethylenically unsaturated reactive group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure:

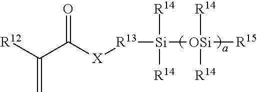

wherein R¹² is H or methyl; X is O or NR¹⁶, wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50.

In non-limiting illustrative embodiments, as may be combined with one or more of the preceding paragraphs, the one or more rigid gas permeable contact lens-forming comonomers comprise one or more vinylaromatic compounds, one or more alkyl (meth)acrylates or both.

In non-limiting illustrative embodiments, as may be combined with one or more of the preceding paragraphs, the one or more vinylaromatic compounds comprise one or more of styrene and a C₁ to C₆ alkyl-substituted styrene, and the one or more alkyl (meth)acrylates comprise one or more C₁ to C₁₂ alkyl (meth)acrylates.

In non-limiting illustrative embodiments, as may be combined with one or more of the preceding paragraphs, the C₁ to C₆ alkyl-substituted styrene is a tri C₁ to C₆ alkyl-substituted styrene.

In non-limiting illustrative embodiments, as may be combined with one or more of the preceding paragraphs, the branched crosslinking agent comprises a branched crosslinking agent having two or more ethylenically unsaturated reactive groups.

In non-limiting illustrative embodiments, as may be combined with one or more of the preceding paragraphs, the branched crosslinking agent comprises a branched crosslinking agent having two to about six ethylenically unsaturated reactive groups.

In non-limiting illustrative embodiments, as may be combined with one or more of the preceding paragraphs, the branched crosslinking agent comprises an alkyl glycol crosslinking agent having two or more ethylenically unsaturated reactive groups.

In non-limiting illustrative embodiments, as may be combined with one or more of the preceding paragraphs, the alkyl glycol crosslinking agent having two or more ethylenically unsaturated reactive groups is ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, nepentyl glycol di(meth)acrylate, polypropylene glycol di(meth)acrylate, or mixtures thereof.

In non-limiting illustrative embodiments, as may be combined with one or more of the preceding paragraphs, the branched crosslinking agent comprises a polysiloxane represented by the following structure:

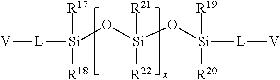

wherein each V is an independently ethylenically unsaturated reactive group, R¹⁷ to R²² are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 2 to 60.

In non-limiting illustrative embodiments, as may be combined with one or more of the preceding paragraphs, the branched crosslinking agent comprises a polysiloxane copolymer represented by the following structure:

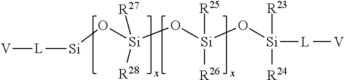

wherein each V is an independently ethylenically unsaturated reactive group, R²³, R²⁴, R²⁵, R²⁶, and R²⁷ are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, R²⁸ is a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, a substituted or unsubstituted C₇-C₃₀ arylalkyl group, and a hydroxyl C₁-C₃₀ alkyl group, L is independently a linking group, and x and y are independently from 1 to 60 where x+y is 2 to 100.

In non-limiting illustrative embodiments, as may be combined with one or more of the preceding paragraphs, the branched crosslinking agent comprises a cyclosiloxane represented by the following structure:

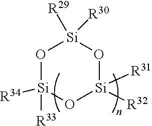

wherein R²⁹, R³⁰, R³¹, R³², R³³ and R³⁴ are independently an ethylenically unsaturated reactive group, and a straight or branched, substituted or unsubstituted C₁-C₃₀ alkyl group, where at least two of R²⁹, R³⁰, R³¹, R³², R³³ and R³⁴ are an ethylenically unsaturated reactive group.

In non-limiting illustrative embodiments, as may be combined with one or more of the preceding paragraphs, the branched crosslinking agent comprises an organosilicone represented by the following structure:

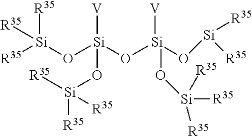

wherein each V is an independently ethylenically unsaturated reactive group, and R³⁵ is independently a straight or branched, substituted or unsubstituted C₁-C₆ alkyl group.

In non-limiting illustrative embodiments, as may be combined with one or more of the preceding paragraphs, the monomeric mixture comprises:
(a) about 30 wt. % to about 75 wt. %, based on the total weight of the monomeric mixture, of the bulky siloxane monomer or prepolymer having the ethylenically unsaturated reactive group,
(b) about 2 wt. % to about 40 wt. %, based on the total weight of the monomeric mixture, of the non-bulky organosilicon-containing monomer having the ethylenically unsaturated reactive group,
(c) about 2 wt. % to about 25 wt. %, based on the total weight of the monomeric mixture, of the rigid gas permeable contact lens-forming comonomer, and
(d) about 2 wt. % to about 30 wt. %, based on the total weight of the monomeric mixture, of the branched cross-linking agent.

In non-limiting illustrative embodiments, as may be combined with one or more of the preceding paragraphs, the monomeric mixture is free of any per- and polyfluoroalkyl substances (PFAS) materials.

In non-limiting illustrative embodiments, as may be combined with one or more of the preceding paragraphs, the rigid gas permeable contact lens has one or more of an oxygen permeability of at least about 90 barrers and up to 250 barrers and a Shore D hardness of from about 55 to about 80.

In non-limiting illustrative embodiments, as may be combined with one or more of the preceding paragraphs, the rigid gas permeable contact lens has an oxygen permeability of from about 90 barrers and up to 150 barrers and a Shore D hardness of from about 65 to about 80.

According to another aspect of the present disclosure, a method for making a rigid gas permeable contact lens comprises:
(a) curing a monomeric mixture in a mold to form a polymerized rigid gas permeable material, the monomeric mixture comprising:
(i) a bulky siloxane monomer or prepolymer having an ethylenically unsaturated reactive group,
(ii) a non-bulky organosilicon-containing monomer having an ethylenically unsaturated reactive group,
(iii) a rigid gas permeable contact lens-forming comonomer, and
(iv) a branched cross-linking agent, and
(b) releasing the polymerized rigid gas permeable material in the shape of a rod from the mold,
(c) transforming the rod into buttons, and
(d) lathing the buttons into a rigid gas permeable contact lens.

In non-limiting illustrative embodiments, as may be combined with one or more of the preceding paragraphs, the bulky siloxane monomer having an ethylenically unsaturated reactive group is a bulky polysiloxanylalkyl (meth)acrylic monomer represented by a structure of Formula I:

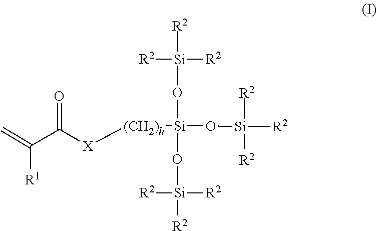

wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure:

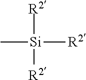

wherein each R²′ independently denotes an alkyl radical or a phenyl radical; and h is 1 to 10; or a bulky siloxane monomer represented by a structure of Formula II:

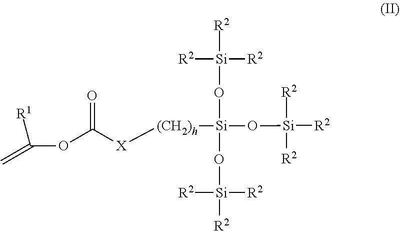

wherein X denotes —NR³— wherein R³ denotes hydrogen or a C₁-C₄ alkyl; R¹ denotes hydrogen or methyl; each R¹⁸ independently denotes an alkyl radical, a phenyl radical or a group represented by the following structure:

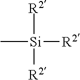

wherein each R²′ independently denotes an alkyl radical or a phenyl radical; and his 1 to 10.

In non-limiting illustrative embodiments, as may be combined with one or more of the preceding paragraphs, the non-bulky organosilicon-containing monomer having the ethylenically unsaturated reactive group is represented by the following structure:

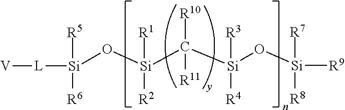

wherein V is an ethylenically unsaturated reactive group, L is a linker group or a bond; R¹, R², R³, R⁴, R⁵, R⁶, R⁷, R⁸, and R⁹ are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure:

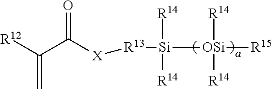

wherein R¹² is H or methyl; X is O or NR¹⁶, wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50.

In non-limiting illustrative embodiments, as may be combined with one or more of the preceding paragraphs, the one or more rigid gas permeable contact lens-forming comonomers comprise one or more vinylaromatic compounds, one or more alkyl (meth)acrylates or both.

In non-limiting illustrative embodiments, as may be combined with one or more of the preceding paragraphs, the one or more vinylaromatic compounds comprise one or more of styrene and a C₁ to C₆ alkyl-substituted styrene, and the one or more alkyl (meth)acrylates comprise one or more C₁ to C₁₂ alkyl (meth)acrylates.

In non-limiting illustrative embodiments, as may be combined with one or more of the preceding paragraphs, the C₁ to C₆ alkyl-substituted styrene is a tri C₁ to C₆ alkyl-substituted styrene.

In non-limiting illustrative embodiments, as may be combined with one or more of the preceding paragraphs, the branched crosslinking agent comprises a branched crosslinking agent having two or more ethylenically unsaturated reactive groups.

In non-limiting illustrative embodiments, as may be combined with one or more of the preceding paragraphs, the branched crosslinking agent comprises a branched crosslinking agent having two to about six ethylenically unsaturated reactive groups.

In non-limiting illustrative embodiments, as may be combined with one or more of the preceding paragraphs, the branched crosslinking agent comprises an alkyl glycol crosslinking agent having two or more ethylenically unsaturated reactive groups.

In non-limiting illustrative embodiments, as may be combined with one or more of the preceding paragraphs, the alkyl glycol crosslinking agent having two or more ethylenically unsaturated reactive groups is ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, nepentyl glycol di(meth)acrylate, polypropylene glycol di(meth)acrylate, or mixtures thereof.

In non-limiting illustrative embodiments, as may be combined with one or more of the preceding paragraphs, the branched crosslinking agent comprises a polysiloxane represented by the following structure:

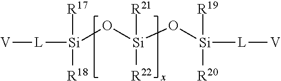

wherein each V is an independently ethylenically unsaturated reactive group, R¹⁷ to R²² are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 2 to 60.

In non-limiting illustrative embodiments, as may be combined with one or more of the preceding paragraphs, the branched crosslinking agent comprises a polysiloxane copolymer represented by the following structure:

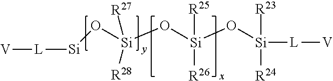

wherein each V is an independently ethylenically unsaturated reactive group, R²³, R²⁴, R²⁵, R²⁶, and R²⁷ are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, R²⁸ is a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, a substituted or unsubstituted C₇-C₃₀ arylalkyl group, and a hydroxyl C₁-C₃₀ alkyl group, L is independently a linking group, and x and y are independently from 1 to 60 where x+y is 2 to 100.

In non-limiting illustrative embodiments, as may be combined with one or more of the preceding paragraphs, the branched crosslinking agent comprises a cyclosiloxane represented by the following structure:

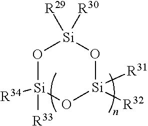

wherein R²⁹, R³⁰, R³¹, R³², R³³ and R³⁴ are independently an ethylenically unsaturated reactive group, and a straight or branched, substituted or unsubstituted C₁-C₃₀ alkyl group, where at least two of R²⁹, R³⁰, R³¹, R³², R³³ and R³⁴ are an ethylenically unsaturated reactive group.

In non-limiting illustrative embodiments, as may be combined with one or more of the preceding paragraphs, the branched crosslinking agent comprises an organosilicone represented by the following structure:

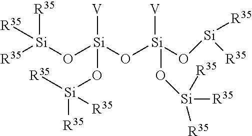

wherein each V is an independently ethylenically unsaturated reactive group, and R³⁵ is independently a straight or branched, substituted or unsubstituted C₁-C₆ alkyl group.

In non-limiting illustrative embodiments, as may be combined with one or more of the preceding paragraphs, the monomeric mixture comprises:
(a) about 30 wt. % to about 75 wt. %, based on the total weight of the monomeric mixture, of the bulky siloxane monomer or prepolymer having the ethylenically unsaturated reactive group,
(b) about 2 wt. % to about 40 wt. %, based on the total weight of the monomeric mixture, of the non-bulky organosilicon-containing monomer having the ethylenically unsaturated reactive group,
(c) about 2 wt. % to about 25 wt. %, based on the total weight of the monomeric mixture, of the rigid gas permeable contact lens-forming comonomer, and
(d) about 2 wt. % to about 30 wt. %, based on the total weight of the monomeric mixture, of the branched cross-linking agent.

In non-limiting illustrative embodiments, as may be combined with one or more of the preceding paragraphs, the monomeric mixture is free of any per- and polyfluoroalkyl substances (PFAS) materials.

In non-limiting illustrative embodiments, as may be combined with one or more of the preceding paragraphs, the rigid gas permeable contact lens has one or more of an oxygen permeability of at least about 90 barrers and up to 250 barrers and a Shore D hardness of from about 55 to about 80.

In non-limiting illustrative embodiments, as may be combined with one or more of the preceding paragraphs, the rigid gas permeable contact lens has an oxygen permeability of from about 90 barrers and up to 150 barrers and a Shore D hardness of from about 65 to about 80.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A rigid gas permeable contact lens comprising a polymerization product of a monomeric mixture comprising:
(a) a bulky siloxane monomer or prepolymer having an ethylenically unsaturated reactive group;
(b) a non-bulky organosilicon-containing monomer having an ethylenically unsaturated reactive group;
(c) a rigid gas permeable contact lens-forming comonomer; and
(d) a branched cross-linking agent.

2. The rigid gas permeable contact lens according to claim 1, wherein the bulky siloxane monomer having an ethylenically unsaturated reactive group is a bulky polysiloxanylalkyl (meth)acrylic monomer represented by a structure of Formula Ia: 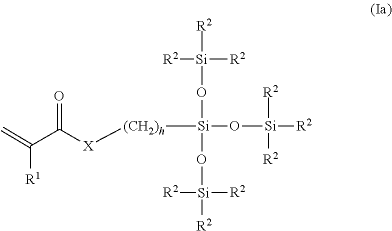
wherein X denotes —O— or —NR³—, where each R³ is hydrogen or a C₁-C₄ alkyl group; R¹ independently denotes hydrogen or methyl; each R² independently denotes an alkyl radical, a phenyl radical or a group represented by the following structure: 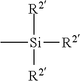
wherein each R²′ independently denotes an alkyl radical or a phenyl radical; and h is 1 to 10; or a bulky siloxane monomer represented by a structure of Formula Ib: 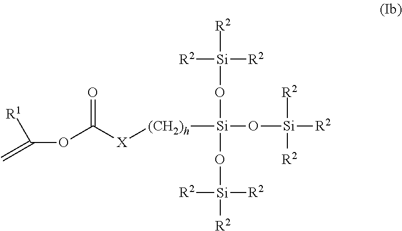
wherein X denotes —NR³— wherein R³ denotes hydrogen or a C₁-C₄ alkyl; R¹ denotes hydrogen or methyl; each R¹⁸ independently denotes an alkyl radical, a phenyl radical or a group represented by the following structure: 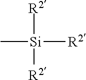
wherein each R²′ independently denotes an alkyl radical or a phenyl radical; and h is 1 to 10.

3. The rigid gas permeable contact lens according to claim 1, wherein the non-bulky organosilicon-containing monomer having the ethylenically unsaturated reactive group is represented by the following structure: 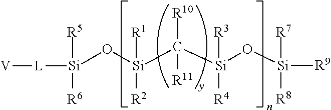
wherein V is an ethylenically unsaturated reactive group, L is a linker group or a bond; R¹, R², R³, R⁴, R⁵, R⁶, R⁷, R⁸, and R° are independently hydrogen an alkyl group, a haloalkyl group, a cycloalkyl group, a heterocycloalkyl group, an alkenyl group, a halo alkenyl group, or an aromatic group; R¹⁰ and R¹¹ are independently hydrogen or alkyl wherein at least one of R¹⁰ and R¹¹ is hydrogen; y is 2 to 7 and n is 1 to 100, or the non-bulky organosilicon-containing monomer is represented by the following structure: 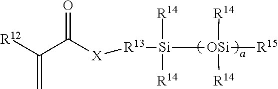
wherein R¹² is H or methyl; X is O or NR¹⁶, wherein R¹⁶ is hydrogen or C₁ to C₄ alkyl, which may be further substituted with one or more hydroxyl groups; R¹³ is a divalent alkyl group, which may further be functionalized with a group selected from the group consisting of an ether group, a hydroxyl group, a carbamate group and combinations thereof; each R¹⁴ is independently a phenyl or C₁ to C₄ alkyl which may be substituted with fluorine, hydroxyl or an ether; R¹⁵ is a C₁ to C₄ alkyl; and a is 2 to 50.

4. The rigid gas permeable contact lens according to claim 1, wherein the one or more rigid gas permeable contact lens-forming comonomers comprise one or more vinylaromatic compounds, one or more alkyl (meth)acrylates or both.

5. The rigid gas permeable contact lens according to claim 4, wherein the one or more vinylaromatic compounds comprise one or more of styrene and a C₁ to C₆ alkyl-substituted styrene, and the one or more alkyl (meth)acrylates comprise one or more C₁ to C₁₂ alkyl (meth)acrylates.

6. The rigid gas permeable contact lens according to claim 1, wherein the branched crosslinking agent comprises a branched crosslinking agent having two or more ethylenically unsaturated reactive groups.

7. The rigid gas permeable contact lens according to claim 1, wherein the branched crosslinking agent comprises a branched crosslinking agent having two to about six ethylenically unsaturated reactive groups.

8. The rigid gas permeable contact lens according to claim 1, wherein the branched crosslinking agent comprises an alkyl glycol crosslinking agent having two or more ethylenically unsaturated reactive groups.

9. The rigid gas permeable contact lens according to claim 8, wherein the alkyl glycol crosslinking agent having two or more ethylenically unsaturated reactive groups is ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, nepentyl glycol di(meth)acrylate, polypropylene glycol di(meth)acrylate, or mixtures thereof.

10. The rigid gas permeable contact lens according to claim 1, wherein the branched crosslinking agent comprises a polysiloxane represented by the following structure: 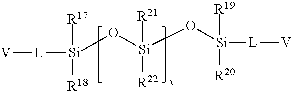
wherein each V is an independently ethylenically unsaturated reactive group, R¹⁷ to R²² are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, L is independently a linking group and x is from 2 to 60.

11. The rigid gas permeable contact lens according to claim 1, wherein the branched crosslinking agent comprises a polysiloxane copolymer represented by the following structure: 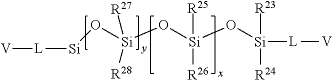
wherein each V is an independently ethylenically unsaturated reactive group, R²³, R²⁴, R²⁵, R²⁶, and R²⁷ are independently a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, R²⁸ is a straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, a substituted or unsubstituted C₇-C₃₀ arylalkyl group, and a hydroxyl C₁-C₃₀ alkyl group, L is independently a linking group, and x and y are independently from 1 to 60 where x+y is 2 to 100.

12. The rigid gas permeable contact lens according to claim 1, wherein the branched crosslinking agent comprises a cyclosiloxane represented by the following structure: 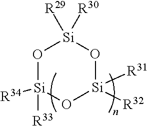
wherein R²⁹, R³⁰, R³¹, R³², R³³ and R³⁴ are independently an ethylenically unsaturated reactive group, and a straight or branched, substituted or unsubstituted C₁-C₃₀ alkyl group, where at least two of R²⁹, R³⁰, R³¹, R³², R³³ and R³⁴ are an ethylenically unsaturated reactive group.

13. The rigid gas permeable contact lens according to claim 1, wherein the branched crosslinking agent comprises an organosilicone represented by the following structure: 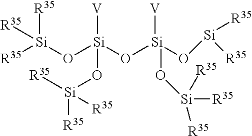
wherein each V is an independently ethylenically unsaturated reactive group, and R³⁵ is independently a straight or branched, substituted or unsubstituted C₁-C₆ alkyl group.

14. The rigid gas permeable contact lens according to claim 1, wherein the monomeric mixture comprises:
(a) about 30 wt. % to about 75 wt. %, based on the total weight of the monomeric mixture, of the bulky siloxane monomer or prepolymer having the ethylenically unsaturated reactive group;
(b) about 2 wt. % to about 40 wt. %, based on the total weight of the monomeric mixture, of the non-bulky organosilicon-containing monomer having the ethylenically unsaturated reactive group;
(c) about 2 wt. % to about 25 wt. %, based on the total weight of the monomeric mixture, of the rigid gas permeable contact lens-forming comonomer; and
(d) about 2 wt. % to about 30 wt. %, based on the total weight of the monomeric mixture, of the branched cross-linking agent.

15. The rigid gas permeable contact lens according to claim 1, wherein the monomeric mixture is free of any per- and polyfluoroalkyl substances (PFAS) materials.

16. The rigid gas permeable contact lens according to claim 1, having one or more of an oxygen permeability of at least about 90 barrers and up to 250 barrers and a Shore D hardness of from about 55 to about 80.

17. The rigid gas permeable contact lens according to claim 1, having an oxygen permeability of from about 90 barrers and up to 150 barrers and a Shore D hardness of from about 65 to about 80.

18. A method for making a rigid gas permeable contact lens, comprising:
(a) curing a monomeric mixture in a mold to form a rigid gas permeable contact lens, the monomeric mixture comprising:
(i) a bulky siloxane monomer or prepolymer having an ethylenically unsaturated reactive group;
(ii) a non-bulky organosilicon-containing monomer having an ethylenically unsaturated reactive group;
(iii) a rigid gas permeable contact lens-forming comonomer; and
(iv) a branched cross-linking agent; and
(b) releasing the rigid gas permeable contact lens from the mold.

19. The method according to claim 18, wherein the monomeric mixture comprises:
(a) about 30 wt. % to about 75 wt. %, based on the total weight of the monomeric mixture, of the bulky siloxane monomer or prepolymer having the ethylenically unsaturated reactive group;
(b) about 2 wt. % to about 40 wt. %, based on the total weight of the monomeric mixture, of the non-bulky organosilicon-containing monomer having the ethylenically unsaturated reactive group;
(c) about 2 wt. % to about 25 wt. %, based on the total weight of the monomeric mixture, of the rigid gas permeable contact lens-forming comonomer; and
(d) about 2 wt. % to about 30 wt. %, based on the total weight of the monomeric mixture, of the branched cross-linking agent.

20. A method for making a rigid gas permeable contact lens, comprising:
(a) curing a monomeric mixture in a mold to form a polymerized rigid gas permeable material, the monomeric mixture comprising:
(i) a bulky siloxane monomer or prepolymer having an ethylenically unsaturated reactive group,
(ii) a non-bulky organosilicon-containing monomer having an ethylenically unsaturated reactive group,
(iii) a rigid gas permeable contact lens-forming comonomer, and
(iv) a branched cross-linking agent;
(b) releasing the polymerized rigid gas permeable material in the shape of a rod from the mold;
(c) transforming the rod into buttons; and
(d) lathing the buttons into a rigid gas permeable contact lens.
